(19) United States
(12) Patent Application Publication
(10) Pub. No.: US 2019/0055459 A1
(43) Pub. Date: Feb. 21, 2019

(54) Compositions comprising aromatic compounds for use in oil and/or gas wells and related methods

(71) Applicant: Flotek Chemistry, LLC, Houston, TX (US)

(72) Inventors: Andrei Zelenev, Spring, TX (US); Paul Ashcraft, Cypress, TX (US); Eric Stubbings, Houston, TX (US)

(73) Assignee: Flotek Chemistry, LLC, Houston, TX (US)

(21) Appl. No.: 15/999,142

(22) Filed: Aug. 17, 2018

Related U.S. Application Data
(60) Provisional application No. 62/547,235, filed on Aug. 18, 2017.

(51) Int. Cl. C09K 8/536; C09K 8/524; C09K 8/70; C09K 8/60; C09K 8/92

(52) U.S. Cl. CPC C09K 8/536; C09K 8/524; C09K 2208/04; C09K 8/602; C09K 8/92; C09K 8/70

(57) ABSTRACT

Compositions comprising aromatic compounds for use in various aspects of a life cycle of an oil and/or gas well, and related methods, are generally provided. In some embodiments, the composition is an emulsion or a microemulsion comprising a cashew nut shell liquid, a derivatized cashew nut shell liquid, an aromatic compound having a melting point above room temperature, and/or a non-aromatic compound having a melting point above room temperature. In some embodiments, the emulsion or the microemulsion comprises an aqueous phase, a non-aqueous phase, and at least one surfactant, and an additive which is an aromatic compound or mixture of aromatic compounds having a melting point above room temperature.

### RELATED APPLICATIONS

This application claims priority under 35 U.S.C. § 119(e) to U.S. Provisional Application No. 62/547,235, filed Aug. 18, 2017, and entitled “Compositions Comprising Aromatic Compounds for use in Oil and/or Gas Wells and Related Methods”, which is incorporated herein in its entirety for all purposes.

### FIELD OF INVENTION

Compositions comprising aromatic compounds for use in various aspects of the life cycle of an oil and/or gas well, and related methods, are provided.

### BACKGROUND OF INVENTION

Fluid compositions are commonly employed in a variety of operations related to the extraction of hydrocarbons, such as well stimulation. Subterranean formations are often stimulated to improve recovery of hydrocarbons. Common stimulation techniques include hydraulic fracturing. Hydraulic fracturing consists of the high pressure injection of a fluid containing suspended proppant into the wellbore in order to create fractures in the rock formation and facilitate production from low permeability zones. All chemicals pumped downhole in an oil and/or gas well can filter through the reservoir rock and block pore throats with the possibility of creating formation damage. It is well known that fluid invasion can significantly reduce hydrocarbon production from a well. In order to reduce fluid invasion, compositions are generally added to the well-treatment fluids to help unload the residual aqueous treatment from the formation.

Accordingly, although a number of compositions are known in the art, there is a continued need for more effective compositions for use in treatment of an oil and/or gas well.

### SUMMARY OF INVENTION

Generally, compositions comprising aromatic compounds for use in various aspects of the life cycle of an oil and/or gas well, and related methods, are provided.

In one aspect, this disclosure is generally directed to an emulsion or a microemulsion. In some embodiments, the microemulsion is a microemulsion for treating an oil and/or gas well having a wellbore. In some embodiments, the microemulsion comprises an aqueous phase; a surfactant; and a non-aqueous phase comprising cashew nut shell liquid (CNSL).

In some embodiments, a microemulsion for treating an oil and/or gas well having a wellbore comprises an aqueous phase; a surfactant; and a non-aqueous phase comprising derivatized CNSL.

In some embodiments, a microemulsion for treating an oil and/or gas well having a wellbore comprises an aqueous phase; a surfactant; and a non-aqueous phase comprising CNSL and derivatized CNSL.

In some embodiments, the microemulsion for treating an oil and/or gas well having a wellbore comprises an aqueous phase; a surfactant; and a non-aqueous phase comprising at least one terpene and at least one additive, wherein the additive is an aromatic compound having a melting point above room temperature. In some embodiments, the non-aqueous phase comprises a non-aromatic compound having a melting point above room temperature.

In some embodiments, a microemulsion for treating an oil and/or gas well having a wellbore comprises an aqueous phase; a surfactant; and a non-aqueous phase comprising at least one terpene and at least one additive, wherein the additive is an aromatic compound having a melting point above 15° C.

In another aspect, this disclosure is generally directed toward a method. In some embodiments, the method is a method of treating an oil and/or gas well having a wellbore. In some embodiments, the method comprises delivering a composition into the wellbore, wherein the composition comprises a microemulsion, wherein the microemulsion comprises: an aqueous phase; a surfactant; and a non-aqueous phase comprising cashew nut shell liquid; and wherein the composition enhances flowback and oil and/or gas production from the wellbore.

In some embodiments, a method of treating an oil and/or gas well having a wellbore comprises delivering a composition into the wellbore comprising a microemulsion. The microemulsion comprises an aqueous phase; a surfactant; and a non-aqueous phase comprising derivatized cashew nut shell liquid. The composition enhances flowback and oil and/or gas production from the wellbore.

In some embodiments, a method of treating an oil and/or gas well having a wellbore comprises delivering a composition into the wellbore comprising a microemulsion. The microemulsion comprises an aqueous phase; a surfactant; and a non-aqueous phase comprising at least one terpene and at least one additive. The additive is an aromatic compound having a melting point above 15° C. The microemulsion enhances flowback and oil and/or gas production from the wellbore.

The use of a CNSL compound, a derivatized CNSL compound (e.g., ethoxylated CNSL), an aromatic compound with a melting point above room temperature (i.e., about 15° C.), and/or a non-aromatic compound with a melting point above room temperature (i.e., about 15° C.) in the emulsion or microemulsion composition may have functional performance benefits, cost benefits, or both.

Other aspects, embodiments, and features of the methods and compositions will become apparent from the following detailed description. All patent applications and patents incorporated herein by reference are incorporated by reference in their entirety. In case of conflict, the present specification, including definitions, will control.

### DETAILED DESCRIPTION

Compositions comprising aromatic compounds for use in various aspects of a life cycle of an oil and/or gas well, and related methods, are generally provided. As used herein, the term “compound” may be used interchangeably with the word “substance.” In some embodiments, the composition comprises an aromatic compound having a melting point above about room temperature. As used herein, room temperature is generally understood to mean from about 15° C. Those of ordinary skill in the art will be aware of means for determining the melting point of a compound or a mixture of compounds (e.g., using a melting point apparatus).

In some embodiments, the composition comprises, consists essentially of, or consists of an aromatic compound or mixture of compounds having a melting point above room temperature and at least one surfactant. In some embodiments, the composition is an emulsion or microemulsion comprising an aqueous phase, a non-aqueous phase, at least one surfactant, and an additive which is an aromatic compound or mixture of aromatic compounds having a melting point above room temperature.

In some embodiments, the composition comprises cashew nut shell liquid (CNSL). The CNSL may be a liquid at room temperature. In some embodiments, the composition comprises, consists essentially of, or consists of CNSL and a surfactant. In some embodiments, the composition is an emulsion or microemulsion comprising an aqueous phase, a non-aqueous phase comprising CNSL, at least one surfactant, and optionally other additives. The non-aqueous phase may further comprise at least one other solvent type (e.g., a terpene).

In some embodiments, the compositions (e.g., emulsions or microemulsions) are used in methods of treating an oil and/or gas well having a wellbore. In some embodiments, a composition is delivered into the wellbore and enhances flowback and oil and/or gas production from the wellbore. For example, one method to enhance flowback and increase oil and/or gas production from the wellbore is to reduce or eliminate asphaltenic deposits from the well.

In oil production, the wellbore is typically filled with fluids, either water, brine, oil, or a combination of these fluids. In some cases, production of oil or gas may be reduced due to the deposition of wax, asphaltenes, or organic scale. Sometimes, corrosion can also be a problem. To remedy these problems, the wellbore may need to be treated with a solvent or with other chemistries. There is a continued need for new materials capable of forming suitable treatments for purposes such as, for example, cleaning out a wellbore or stimulating production of hydrocarbons (liquid, gas, or a combination thereof). Materials that are naturally derived have recently become of particular interest to companies who place a large emphasis on the promotion of renewable technologies with minimal negative impact on the environment. As will be known to those of ordinary skill in the art, it is a challenge to find materials that can be used to form an emulsion or a microemulsion with the ability to enhance the production of a well, or clean a wellbore of brine, asphaltene, or paraffins. Furthermore, it is not uncommon in the art for a material that has been found capable of forming useful emulsions or microemulsions to be cost-prohibitive at the bulk quantities required for the oil and gas industry.

Non-Aqueous Phase

The composition (e.g., emulsion or microemulsion) generally comprises a non-aqueous phase.

Aromatic Compounds

In some embodiments, the non-aqueous phase of the composition (e.g., a microemulsion composition) comprises one additive or more than one additive which is an aromatic compound or a mixture of aromatic compounds having a melting point above room temperature (e.g., above about 15° C., such as at or above about 25° C.). The aromatic compounds may be natural or synthetic. Additional non-limiting examples of aromatic compounds having a melting point above room temperature (e.g., 15° C.) include derivatized and underivatized naphthalene, anthracene, phenanthrene, pyrene, fluoranthene, benzopyrene, chrysene, perylene, phenol, catechol, aminophenol, coniferyl alcohol and esters thereof, synapyl alcohol, syringol, syringaldehyde, syringic acid, acetosyringone, sinapine, canolol, cannabinol, cannabidiol, derivatized phenols, phenolic natural products, phenolic resins, lignin, derivatized lignin, tributylphenol ethoxylate, derivatized cashew nut shell liquid, ethoxylated cashew nut shell liquid, and combinations thereof.

It should be understood that for embodiments described herein wherein the non-aqueous phase comprises an aromatic component that has a melting point above room temperature, that if used above its melting point, this component may be referred to as a solvent, and a person of ordinary skill in the art will be aware of methods and conditions for which the compound (or mixture of compounds) having a melting point above room temperature is in a liquid form. In some embodiments, a composition comprises an aromatic compound that is a solid at room temperature. The aromatic compound may be employed at temperatures above its melting point where it is a liquid. When dissolved in a solvent, some aromatic compounds may possess surfactant properties and function as dispersants, humectants, foamers, defoamers, wetters, emulsion stabilizers and/or emulsion breakers. For example, the aromatic compound having a melting point above room temperature may be utilized at a temperature above the melting point.

Those of ordinary skill in the art will be aware of means for determining the melting point of a compound or a mixture of aromatic compounds (e.g., using a melting point apparatus).

Suitable aromatic compounds can also be selected from, for example, polycondensed aromatic compounds, polycyclic aromatic compounds, derivatized phenols, phenolic natural products, phenolic resins, lignin-based compounds, derivatized lignin, naphthalenic, anthracenic and phenanthrenic compounds, compounds derived from cannabis, and combinations thereof. In some embodiments aromatic compounds can be heterocyclic compounds.

In some embodiments, the one or more aromatic compounds are selected from the group consisting of cardol, cardanol, anacardic acid, 2-methylcardol, and combinations thereof. Other non-limiting examples of aromatic compounds include natural phenolic plant-based derivatives such as those coming from the Rubus genus, gallic acid and/or derivatives thereof, thymol and/or derivatives thereof, pyrogallol and/or derivatives thereof, tannin and/or derivatives thereof, lignin and/or derivatives thereof, or combinations thereof.

CNSL

In some embodiments, the additive in the non-aqueous phase may comprise one aromatic compound or more than one (e.g. multiple) aromatic compounds (e.g., two compounds, three compounds, etc.). In these embodiments, the one or more aromatic compounds are those typically found in CNSL, for example, cardol, cardanol, anacardic acid, 2-methylcardol, or combinations thereof. In some embodiments, the CNSL or the aromatic compounds described above found in CNSL, may function as oil-soluble surfactants. In other words, some embodiments relate to CNSL that are distributed in the composition in a location other than an non-aqueous phase, such as at an interface between the non-aqueous phase and an aqueous phase.

Derivatized CNSL

In some embodiments, derivatized CNSL may be used in the composition. Derivatized CNSL is obtained as a result of chemical reaction between CNSL and various derivatization agents. One non-limiting example of a derivatized CNSL is ethoxylated CNSL.

Some non-limiting examples of CNSL derivatization can be found in D. Lomonaco, G. Mele, S. Mazzetto, “Cashew Nutshell Liquid (CNSL): From and Agro-industrial Waste to a Sustainable Alternative to Petrochemical Resources”, Chapter 2 in “Cashew Nut Shell Liquid: A Goldfield for Functional Materials”, Edited by Anikumar, P., Springer, 2017, each of which is incorporated herein by reference in its entirety and for all purposes. In some embodiments, the derivatized CNSL may comprise an ethoxylated CNSL with a degree of ethoxylation of less than or equal to 7 moles of ethylene oxide per mole of CNSL, which are typically insoluble in water, but may be soluble and be part of the non-aqueous phase.

In some embodiments, derivatized CNSL comprises derivatized cardol, derivatized cardanol, derivatized anacardic acid, derivatized 2-methylcardol, derivatized polymers thereof, CNSL-based surfactant, CNSL gemini surfactant, CNSL azo compounds, CNSL-based glycolipids, CNSL glucosides, sulfonated CNSL, sulfonated pentadecylphenols, sulfated pentadecylpolyphenols, alkoxylated CNSL, ethoxylated CNSL, propoxylated CNSL, ethoxylated-propoxylated CNSL, butoxylated CNSL, butoxylated-ethoxylated CNSL, CNSL polyols, CNSL-based Mannich polyols, CNSL esters, CNSL ethers, CNSL polyesters, CNSL polyethers, CNSL amino alcohols, CNSL amines, CNSL substituted amines, CNSL amides, CNSL carboxylates, CNSL phosphates, CNSL sulfonates, CNSL sulfates, CNSL phosphates, CNSL phosphonates, CNSL succinates, CNSL polyester diols, CNSL polyether diols, CNSL polyether triols, CNSL polyester triols, CNSL polyester polyethers, CNSL polyether polyols, CNSL polyester polyols, CNSL salt, CNSL quaternary ammonium salts, CNSL pyridinium salts, CNSL phosphonium salts, 2,4-sodium disulphonate-5-n-pentadecylphenol, 8-(3-methoxy)-phenyl-N,N,N-triethyl-1-(n)-octylammonium chloride, 8-(3-methoxy)-phenyl-N,N,N-triethyl-1-(n)-octylammonium bromide, 8-(3-methoxy)-phenyl-N,N,N-triethyl-1-(n)-octylammonium fluoride, 8-(3-methoxy)-phenyl-N,N,N-triethyl-1-(n)-octylammonium iodide, N-cardanyl taurine amide, cardanol oligomers, cardol oligomers, anacardic acid oligomers, 2-methyl cardol oligomers, CNSL diethyl phosphate, CNSL phthalocyanines, CNSL porphyrines, CNSL fullerenes, CNSL fullerpyrrolidines, biscardanol, biscardol, bisanacardic acid, bis-2-methlyl cardol, CNSL phosphate ester, 8-hydroxy-3-tridecyl-3,4-dihydroisochromen-1-one, 8-hydroxy-3-tridecyl-1H-isochromen-1-one, sodium cardanol sulfonate surfactant, a CNSL amine oxide, a CNSL betaine, a CNSL hydroxysultane, cardanol ethoxylate sulfosuccinate, cardanol ethoxylate sulfate, cardanol ethoxylate sulfonate, cardol ethoxylate sulfosuccinate, cardol ethoxylate sulfate, cardol ethoxylate sulfonate, 2-methyl cardol ethoxylate sulfosuccinate, 2-methylcardol ethoxylate sulfate, 2-methyl cardol ethoxylate sulfonate, anacardic acid ethoxylate sulfosuccinate, anacardic acid ethoxylate sulfate, anacardic acid ethoxylate sulfonate, sodium salts of anacardic acid, sodium salts of tetrahydroanacardic acid, N,N-dibutyl-3-pentadecyl cyclohexylamine, N,N-dimethyl-3-pentadecyl cyclohexylamine, N-benzyl-N,N-dimethyl-3-pentadecylcyclohexan-1-aminium, betaine 2-(dimethyl(3-pentadecylcyclohexyl)ammonio)acetate, 3-pentadecylphenol, and derivatized 3-pentadecylphenol.

In some embodiments, 2-methylcardol comprises 2-methyl-5-pentadecylresorcinol, 2-methyl-5-(8′-pentadecenyl)resorcinol, 2-methyl-5-(8′,11′-pentadecadienyl)resorcinol, and 2-methyl-5-(8′,11′,14′-pentadecatrienyl)resorcinol.

In some embodiments, the derivatized 2-methylcardol comprises derivatized 2-methyl-5-pentadecylresorcinol, derivatized 2-methyl-5-(8′-pentadecenyl)resorcinol, derivatized 2-methyl-5-(8′,11′-pentadecadienyl)resorcinol, derivatized 2-methyl-5-(8′,11′,14′-pentadecatrienyl)resorcinol, and mixtures thereof.

In some embodiments, the derivatized CNSL comprises a halogenated CNSL. In some embodiments, the halogenated CNSL comprises chlorinated cardanol, chlorinated to cardol, chlorinated anacardic acid, and chlorinated 2-methyl cardol. In some embodiments, the halogenated CNSL comprises fluorinated cardanol, fluorinated cardol, fluorinated anacardic acid, and fluorinated 2-methyl cardol. In some embodiments, the halogenated CNSL comprises brominated cardanol, brominated cardol, brominated anacardic acid, and brominated 2-methyl cardol. In some embodiments, the halogenated CNSL comprises iodine-substituted cardanol, iodine-substituted cardol, iodine-substituted anacardic acid, and iodine-substituted 2-methyl cardol.

In some embodiments, the derivatized CNSL comprises an olefin metathesis reaction product.

In some embodiments, the derivatized CNSL comprises a CNSL in which alcohol and/or acid groups have been converted into aldehyde, ketone or ester groups.

In some embodiments, the derivatized CNSL comprises a hydrogenated CNSL. In some embodiments, the hydrogenated CNSL comprises tetrahydroanacardic acid and 3-pentadecylphenol. In some embodiments, the derivatized CNSL comprises 3-pentadecylphenol.

In some embodiments, the derivatized CNSL comprises derivatized CNSL resin, CNSL formaldehyde resin, CNSL phenol formaldehyde resin, CNSL cardanol formaldehyde resin, CNSL hexamine resin, CNSL cardanol hexamine resin, 3-pentadecylphenol resin. In some embodiments, the derivatized CNSL resin comprises Novolac resins and Resoles resins.

In some embodiments, the derivatized CNSL comprises oxidized CNSL.

In some embodiments, the derivatized CNSL comprises polymerized CNSL.

In some embodiments, the derivatized CNSL comprises CNSL reacted with nitric acid and/or nitrous acid.

In some embodiments, the derivatized CNSL comprises CNSL isocyanates.

In some embodiments, the derivatized CNSL comprises CNSL which is pH-adjusted CNSL.

Non-Aromatic Compounds

In some embodiments, the non-aqueous phase comprises an additive that is a non-aromatic compound that has a melting point above about room temperature. It should be understood that for embodiments described herein wherein the non-aqueous phase comprises a non-aromatic component that has a melting point above room temperature, that if used above its melting point, this component may be referred to as a solvent, and a person of ordinary skill in the art will be aware of methods and conditions for which the compound (or mixture of compounds) having a melting point above room temperature is in a liquid form. For example, the non-aromatic compound having a melting point above room temperature may be utilized at a temperature above the melting point. In some embodiments, a composition comprises a non-aromatic compound that is a solid at room temperature. The non-aromatic compound may be employed at temperatures above its melting point where it is a liquid.

Those of ordinary skill in the art will be aware of means for determining the melting point of a compound or a mixture of non-aromatic compounds (e.g., using a melting point apparatus).

Suitable non-aromatic compounds with a melting temperature above room temperature may be selected from classes of saturated and unsaturated hydrocarbons, fatty alcohols, fatty aldehydes, fatty ketones, fatty acids, fatty amides, fatty amines, fatty ethers, esters of fatty acids and fatty alcohols, typically having a hydrocarbon chain length of 10 or more carbon atoms. Some non-limiting examples of suitable non-aromatic compounds include abietic acid, myristic acid, decanoic acid, tridecyl alcohol, dodecyl amine. In some embodiments, the non-aromatic compound can be a waste product or a by-product of an industrial process. One example of such material is a byproduct of the pulping process, such as a tall oil distillate rich in saturated fatty acids, sold by Ingevity Corporation as Liqrene® D. The incorporation of a non-aromatic compound with a melting point above room temperature into the microemulsion may provide cost reduction benefits as well as functional benefits. One non-limiting example of such functional benefit is corrosion inhibition.

In some embodiments, the non-aqueous phase comprising the non-aromatic compound with melting point above room temperature is dissolved in more than one solvent which are then combined to form a microemulsion. Such an approach may be utilized to maximize the content of the non-aromatic compound in the microemulsion. Some non-aromatic substances with melting point above room temperature are sparingly soluble or completely insoluble in water.

In some embodiments, the non-aqueous phase may comprise a second component (e.g., a second type of solvent) in which the aromatic compound and/or non-aromatic compound is soluble, and thus, the non-aqueous phase comprises a solution. In embodiments wherein the non-aqueous phase comprises CNSL and a second type of solvent (e.g., a terpene), the non-aqueous phase is a solution. In some embodiments, the non-aqueous phase comprising the aromatic compound and/or non-aromatic compound is dissolved in more than one solvent which are then combined to form a microemulsion. Such an approach may be utilized to maximize the content of the aromatic compound in the microemulsion.

The non-aqueous phase may comprise a single component (e.g., a solvent) or more than one type of component (e.g., more than one solvent). For example, the non-aqueous phase may comprise a single type of solvent or a combination of two or more types of solvent. In some non-limiting embodiments, the solvent comprises CNSL and at least one other solvent selected from the group consisting of terpenes, terpenoids, terpene alcohols, alkyl aliphatic carboxylic acid esters, aliphatic liquids, aromatic compounds (e.g., water-immiscible aromatic compounds), and water-immiscible aromatic liquids, or combinations thereof. In some embodiments, the solvent comprises an additive comprising an aromatic compound or mixture of aromatic compounds having a melting point above room temperature and at least one other solvent selected from the group consisting of terpenes, terpenoids, alkyl aliphatic carboxylic acid esters, aliphatic liquids, aromatic compounds (e.g., water-immiscible aromatic compounds), water-immiscible aromatic liquids, and combinations thereof. In some embodiments, the solvent is a liquid that dissolves other substances, for example, residues or other substances found at or in a wellbore (e.g. kerogens, asphaltenes, paraffins, organic scale).

In some embodiments, the aromatic compound or mixture of aromatic compounds having a melting point above room temperature (e.g., derivatized CNSL) may present advantages such as low cost, natural sourcing (vs. synthetic), and biodegradability. In some embodiments, the aromatic compound or mixture of aromatic compounds may contribute to the formation of stable microemulsions. In some embodiments, the aromatic compound or mixture of compounds may be provided in an amount from about 1 wt % to about 99 wt %, from about 10 wt % to about 99 wt %, or from about 11 wt % to about 99 wt % of the total weight of the composition.

In some embodiments, the composition comprises from about 1 wt % to about 99 wt %, from about 2 wt % to about 99 wt %, from about 3 wt % to about 99 wt %, from about 4 wt % to about 99 wt %, from about 5 wt % to about 99 wt %, from about 6 wt % to about 99 wt %, from about 7 wt % to about 99 wt %, from about 8 wt % to about 99 wt %, from about 9 wt % to about 99 wt %, from about 10 wt % to about 99 wt %, from about 11 wt % to about 99 wt %, from about 12 wt % to about 99 wt %, from about 13 wt % to about 99 wt %, from about 14 wt % to about 99 wt %, from about 15 wt % to about 99 wt %, from about 16 wt % to about 99 wt %, from about 17 wt % to about 99 wt %, from about 11 wt % to about 60 wt %, from about 11 wt % to about 30 wt %, or from about 11 wt % to about 25 wt % of the aromatic compound or mixture of compounds versus the total weight of the composition.

In some embodiments, the composition (e.g., microemulsion) comprises an aromatic compound or mixture of aromatic compounds that is a component of CNSL or derivatives thereof. CNSL may be raw cashew nut shell liquid, or cashew nut shell liquid refined using techniques known to a person skilled in the art.

It is recognized that as a natural material, CNSL may come in different grades of quality depending on extraction and refining processes. CNSL may comprise a mixture of different substances that can be present in different ratios depending on the crop and geography of plant species from which it is produced. CNSL may undergo a refinement process, the details of which would be known to those skilled in the art. One example of such refinement process is distillation. As a result of the refinement process, the ratios of components comprising CNSL can be altered, or some constituents (e.g. components) can even be removed. In certain embodiments, refining of CNSL may include chemical alteration, such as decarboxylation.

CNSL may sometimes be described as “refined CNSL” or “unrefined CNSL” by various vendors. The refined CNSL would be commonly available from different vendors and may be labeled as “refined” without a description of the specific refining processes involved. As used herein, “unrefined CNSL” means raw CNSL that did not go through a refinement process, but may be obtained by a variety of extraction techniques. There may be multiple grades of quality for unrefined CNSL.

CNSL is a natural byproduct of the cashew industry and is a source of naturally occurring phenols. CNSL is traditionally obtained as a byproduct during the process of removing the cashew nut kernel from the nut (e.g., see V. Balachandran et al, Chem. Soc. Rev. 42 (2013) 427-438 and P. Gedam, Progress in Organic Coatings 14 (1986) 115-157), herein incorporated by reference). As will be known to those of ordinary skill in the art, CNSL generally comprises a combination of cardanol, cardol, and anacardic acid in varying ratios.

In some embodiments, the CNSL may be provided in an amount from about 1 wt % to about 99 wt %, from about 10 wt % to about 99 wt %, or from about 11 wt % to about 99 wt % of the total weight of the composition. Without wishing to be bound by theory, such materials may comprise the non-aqueous phase within a microemulsion.

In some embodiments, the composition comprises from about 1 wt % to about 99 wt %, from about 2 wt % to about 99 wt %, from about 3 wt % to about 99 wt %, from about 4 wt % to about 99 wt %, from about 5 wt % to about 99 wt %, from about 6 wt % to about 99 wt %, from about 7 wt % to about 99 wt %, from about 8 wt % to about 99 wt %, from about 9 wt % to about 99 wt %, from about 10 wt % to about 99 wt %, from about 11 wt % to about 99 wt %, from about 12 wt % to about 99 wt %, from about 13 wt % to about 99 wt %, from about 14 wt % to about 99 wt %, from about 15 wt % to about 99 wt %, from about 16 wt % to about 99 wt %, from about 17 wt % to about 99 wt %, from about 11 wt % to about 60 wt %, from about 11 wt % to about 30 wt %, or from about 11 wt % to about 25 wt % of CNSL versus the total weight of the composition.

In some embodiments, the composition comprises from about 1 wt % to about 99 wt %, from about 2 wt % to about 99 wt %, from about 3 wt % to about 99 wt %, from about 4 wt % to about 99 wt %, from about 5 wt % to about 99 wt %, from about 6 wt % to about 99 wt %, from about 7 wt % to about 99 wt %, from about 8 wt % to about 99 wt %, from about 9 wt % to about 99 wt %, from about 10 wt % to about 99 wt %, from about 11 wt % to about 99 wt %, from about 12 wt % to about 99 wt %, from about 13 wt % to about 99 wt %, from about 14 wt % to about 99 wt %, from about 15 wt % to about 99 wt %, from about 16 wt % to about 99 wt %, from about 17 wt % to about 99 wt %, from about 11 wt % to about 60 wt %, from about 11 wt % to about 30 wt %, or from about 11 wt % to about 25 wt % of derivatized CNSL versus the total weight of the composition.

Additional Solvents

In some embodiments, the non-aqueous phase of the composition (e.g., microemulsion) further comprises one or more additional types of solvent, creating a solvent blend. In some embodiments, the solvent blend comprises a first type of solvent and a second type of solvent. In some embodiments, the second type of solvent in the solvent blend of the non-aqueous phase of the composition (e.g., emulsion or microemulsion) is a substance with a significant hydrophobic character with linear, branched, cyclic, bicyclic, saturated, or unsaturated structure. Examples of categories of the second type of solvent include but are not limited to terpenes, terpineols, terpene alcohols, aldehydes, ketones, esters, amines, amides, terpenoids, alkyl aliphatic carboxylic acid esters, aliphatic hydrocarbon liquids, water-immiscible hydrocarbon liquids, silicone fluids, and combinations thereof.

Additional details regarding the compositions (e.g., emulsions or microemulsions), as well as the applications of the compositions, are described herein. The terms emulsions and microemulsions should be understood to include emulsions or microemulsions that have a water-continuous phase, that have an oil-continuous phase, or microemulsions that are bicontinuous or have multiple continuous phases of water and oil. In some embodiments, the emulsion or microemulsion has a water-continuous phase. Additional details regarding emulsions and microemulsions and components therein are described herein.

The composition generally comprises a non-aqueous phase. In some embodiments, the non-aqueous phase comprises a solvent blend, comprising at least two types of solvents. For example, the solvent blend may comprise a first type of solvent and a second type of solvent. In some embodiments, the composition comprises from about 1 wt % to about 30 wt %, from about 2 wt % to about 25 wt %, from about 5 wt % to about 25 wt %, from about 15 wt % to about 25 wt %, from about 3 wt % to about 40 wt %, from about 5 wt % to about 30 wt %, or from about 7 wt % to about 22 wt % of the total amount of the solvent blend, versus the total weight of the composition. In some embodiments, the first type of solvent is an aromatic compound and/or the second type of solvent is a terpene.

In some embodiments, the first type of solvent (e.g., an aromatic compound or mixture) and the second type of solvent (e.g., a terpene) in the non-aqueous solvent blend are provided in a ratio from about 1:99 to about 99:1, or from 1:10 to about 10:1, by weight of the first type of solvent to the second type of solvent. In some embodiments, the ratio of the first type of solvent to the second type of solvent is from about 1:5 to 5:1, or from about 1:2 to 2:1. In some embodiments, the first type of solvent (e.g., an aromatic compound or mixture) and the second type of solvent (e.g., a terpene) in the non-aqueous solvent blend are provided in a ratio from about 3:2 to about 3:7, or from 3:2 to about 1:4, by weight of the first type of solvent to the second type of solvent. In some embodiments, the ratio of the first type of solvent to the second type of solvent is from about 9:11 to 7:13, or about 2:3.

In some embodiments, the second type of solvent in the solvent blend in the composition is a substance with a significant hydrophobic character with linear, branched, cyclic, bicyclic, saturated, or unsaturated structure. Examples of categories of the second type of solvent include but are not limited to terpenes, terpineols, terpene alcohols, aldehydes, ketones, esters, amines, and amides. In some embodiments, the solvent blend may comprise a terpene. In some embodiments, the solvent blend may comprise an aliphatic hydrocarbon liquid. In some embodiments, the solvent blend may comprise a water-immiscible hydrocarbon liquid. In some embodiments, the second type of solvent in a non-aqueous solvent blend in the composition is a substance (e.g., a liquid) with a significant hydrophobic character with linear, branched, cyclic, bicyclic, saturated, or unsaturated structure, including terpenes and/or alkyl aliphatic carboxylic acid esters.

Examples of categories of solvents in the solvent blend include, but are not limited to terpenes, terpineols, terpene alcohols, aldehydes, ketones, esters, amines, amides, terpenoids, alkyl aliphatic carboxylic acid esters, aliphatic hydrocarbon liquids, water-immiscible hydrocarbon liquids, silicone fluids, and combinations thereof. Additional details are provided herein.

In some embodiments, the solvent comprises at least one aromatic ester solvent. In some embodiments, the first type of solvent is an aromatic ester solvent. As noted above, the at least one type of solvent may comprise more than one aromatic ester solvent, e.g., a first aromatic ester solvent and a second, different, aromatic ester solvent. For example, in some embodiments, the first type of solvent comprises a first aromatic ester solvent and a second aromatic ester solvent. As used herein, the term “aromatic ester” is given its ordinary meaning in the art and refers to an ester in which the ester oxygen of the carboxylate group is associated with a group comprising an aromatic group. Generally, the aromatic ester solvent is a liquid at room temperature and pressure. In some embodiments, the aromatic ester comprises the formula:

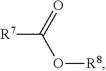

wherein R⁷ comprises an aromatic group and R⁸ is a suitable substituent. In some embodiments, R⁷ comprises an optionally substituted aryl. In some embodiments, R⁷ is an optionally substituted aryl. In some embodiments, R⁷ comprises an optionally substituted phenyl. In some embodiments, R⁷ is an optionally substituted phenyl. In some embodiments, R⁷ is substituted with a hydroxyl group. In some embodiments, R⁷ is phenyl. In some embodiments, R⁷ is Ar—CH═CH—, wherein Ar is an aromatic group. In some embodiments Ar is optionally substituted phenyl. In some embodiments, Ar is phenyl. In some embodiments, R⁸ is selected from the group consisting of hydrogen, alkyl, optionally substituted alkyl, optionally substituted heteroalkyl, optionally substituted cycloalkyl, optionally substituted aryl, and optionally substituted heterocycle. In some embodiments, the optionally substituted heterocycle may be an optionally substituted cycloheteroalkyl or an optionally substituted heteroaryl. In some embodiments, R⁸ is an optionally substituted alkyl. In some embodiments, R⁸ is an alkyl substituted with an aryl group. In some embodiments, R⁸ is benzyl. In some embodiments, R⁸ is an unsubstituted alkyl. In some embodiments, R⁸ is methyl, ethyl, propyl (e.g., n-propyl, i-propyl), or butyl (e.g., n-butyl, i-butyl, t-butyl). In some embodiments, R⁸ is methyl.

In some embodiments, the aromatic ester solvent is selected from the group consisting of esters of salicylates, benzoates, cinnamates, and phthalates, or combinations thereof. Non-limiting specific examples of aromatic ester solvents include isomers of methyl salicylate, ethyl salicylate, benzyl salicylate, methyl benzoate, ethyl benzoate, benzyl benzoate, methyl cinnamate, ethyl cinnamate. Other aromatic esters include esters of phthalic acid, isophthalic acid, and terephthalic acid where the substituents are linear, branched, aromatic, or cyclic alcohols containing 1 to 13 carbons. Examples include, but are not limited to, 1,2-dimethylthalate, 1,3-dimethylphthalate, 1,4-dimethylphthalate, 1,2-diethylphthalate, 1,3-diethylphthalate, 1,4-diethylphthalate, di-(2-ethylhexyl) phthalate, butyl benzyl phthalate, 1,2-dibutyl phthalate, 1,2-dicotylphthalate. In certain embodiments, the aromatic ester solvent is selected from the group consisting of benzyl benzoate and methyl salicylate, or combinations thereof. In certain embodiments, the aromatic ester solvent is benzyl benzoate. In certain embodiments, the aromatic ester solvent is methyl salicylate.

In some embodiments, the solvent blend may comprise a terpene. In some embodiments, the solvent blend may comprise an aliphatic hydrocarbon liquid. In some embodiments, the solvent blend may comprise a water-immiscible hydrocarbon liquid. In some embodiments, the first type of solvent in a non-aqueous solvent blend in the emulsion or microemulsion is a substance (e.g., a liquid) with a significant hydrophobic character with linear, branched, cyclic, bicyclic, saturated, or unsaturated structure, including terpenes and/or alkyl aliphatic carboxylic acid esters.

Terpenes

In some embodiments, the second type of solvent comprises at least one terpene. In some embodiments, the second type of solvent is a terpene. In some embodiments, the second type of solvent comprises a first terpene and a second, different terpene.

Terpenes are generally derived biosynthetically from units of isoprene. Terpenes may be generally classified as monoterpenes (e.g., having two isoprene units), sesquiterpenes (e.g., having 3 isoprene units), diterpenes, or the like. The term “terpenoid” includes natural degradation products, such as ionones, and natural and synthetic derivatives, e.g., terpene alcohols, ethers, aldehydes, ketones, acids, esters, epoxides, and hydrogenation products (e.g., see Ullmann's Encyclopedia of Industrial Chemistry, 2012, pages 29-45, herein incorporated by reference). In some embodiments, the terpene is a naturally occurring terpene. In some embodiments, the terpene is a non-naturally occurring terpene and/or a chemically modified terpene (e.g., saturated terpene, terpene amine, fluorinated terpene, or silylated terpene). Terpenes that are modified chemically, such as by oxidation or rearrangement of the carbon skeleton, may be referred to as terpenoids. Many references use “terpene” and “terpenoid” interchangeably, and this disclosure will adhere to that usage.

In some embodiments, the terpene is a non-oxygenated terpene. In some embodiments, the terpene is citrus terpene. In some embodiments, the terpene is d-limonene. In some embodiments, the terpene is dipentene. In some embodiments, the terpene is selected from the group consisting of d-limonene, nopol, alpha terpineol, eucalyptol, dipentene, linalool, alpha-pinene, beta-pinene, alpha-terpinene, geraniol, alpha-terpinyl acetate, menthol, menthone, cineole, citranellol, and combinations thereof. As used herein, “terpene” refers to a single terpene compound or a blend of terpene compounds.

In some embodiments, the terpene is an oxygenated terpene. Non-limiting examples of oxygenated terpenes include terpenes containing alcohol, aldehyde, ether, or ketone groups. In some embodiments, the terpene comprises an ether-oxygen, for example, eucalyptol, or a carbonyl oxygen, for example, menthone. In some embodiments, the terpene is a terpene alcohol. Non-limiting examples of terpene alcohols include linalool, geraniol, nopol, α-terpineol, and menthol. Non-limiting examples of oxygenated terpenes include eucalyptol, 1,8-cineol, menthone, and carvone.

### Alkyl Aliphatic Carboxylic Acid Esters

In some embodiments, the solvent blend comprises an alkyl aliphatic carboxylic acid ester. As used herein “alkyl aliphatic carboxylic acid ester” refers to a compound or a blend of compounds having the general formula:

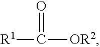

wherein R¹ is a C₆ to C₁₂ optionally substituted aliphatic group, including those bearing heteroatom-containing substituent groups, and R² is a C₁ to C₆ alkyl group. In some embodiments, R¹ is C₆ to C₁₂ alkyl. In some embodiments, R¹ is substituted with at least one heteroatom-containing substituent group. For example, wherein a blend of compounds is provided and each R² is —CH₃ and each R¹ is independently a C₆ to C₁₂ aliphatic group, the blend of compounds is referred to as methyl aliphatic carboxylic acid esters, or methyl esters. In some embodiments, such alkyl aliphatic carboxylic acid esters may be derived from a fully synthetic process or from natural products, and thus comprise a blend of more than one ester. In some embodiments, the alkyl aliphatic carboxylic acid ester comprises butyl 3-hydroxybutyrate, isopropyl 3-hydroxybutyrate, hexyl 3-hydroxylbutyrate, and combinations thereof.

Non-limiting examples of alkyl aliphatic carboxylic acid esters include methyl octanoate, methyl decanoate, a blend of methyl octanoate and methyl decanoate, and butyl 3-hydroxybutyrate.

Alkanes

In some embodiments, the solvent blend comprises an unsubstituted cyclic or acyclic, branched or unbranched alkane. In some embodiments, the cyclic or acyclic, branched or unbranched alkane has from 6 to 12 carbon atoms. Non-limiting examples of unsubstituted, acyclic, unbranched alkanes include hexane, heptane, octane, nonane, decane, undecane, dodecane, and combinations thereof. Non-limiting examples of unsubstituted, acyclic, branched alkanes include isomers of methylpentane (e.g., 2-methylpentane, 3-methylpentane), isomers of dimethylbutane (e.g., 2,2-dimethylbutane, 2,3-dimethylbutane), isomers of methylhexane (e.g., 2-methylhexane, 3-methylhexane), isomers of ethylpentane (e.g., 3-ethylpentane), isomers of dimethylpentane (e.g., 2,2,-dimethylpentane, 2,3-dimethylpentane, 2,4-dimethylpentane, 3,3-dimethylpentane), isomers of trimethylbutane (e.g., 2,2,3-trimethylbutane), isomers of methylheptane (e.g., 2-methylheptane, 3-methylheptane, 4-methylheptane), isomers of dimethylhexane (e.g., 2,2-dimethylhexane, 2,3-dimethylhexane, 2,4-dimethylhexane, 2,5-dimethylhexane, 3,3-dimethylhexane, 3,4-dimethylhexane), isomers of ethylhexane (e.g., 3-ethylhexane), isomers of trimethylpentane (e.g., 2,2,3-trimethylpentane, 2,2,4-trimethylpentane, 2,3,3-trimethylpentane, 2,3,4-trimethylpentane), isomers of ethylmethylpentane (e.g., 3-ethyl-2-methylpentane, 3-ethyl-3-methylpentane), and combinations thereof. Non-limiting examples of unsubstituted cyclic branched or unbranched alkanes include cyclohexane, methylcyclopentane, ethylcyclobutane, propylcyclopropane, isopropylcyclopropane, dimethylcyclobutane, cycloheptane, methylcyclohexane, dimethylcyclopentane, ethylcyclopentane, trimethylcyclobutane, cyclooctane, methylcycloheptane, dirmethylcyclulhexane, ethylcyclohexane, cyclononane, methylcyclooctane, dimethylcycloheptane, ethylcycloheptane, trimethylcyclohexane, ethylmethylcyclohexane, propylcyclohexane, cyclodecane, and combinations thereof. In some embodiments, the unsubstituted cyclic or acyclic, branched or unbranched alkane having 6 to 12 carbon atoms is selected from the group consisting of heptane, octane, nonane, decane, 2,2,4-trimethylpentane (isooctane), propylcyclohexane, and combinations thereof.

Unsaturated Hydrocarbon Solvents

In some embodiments, the solvent blend comprises an unsubstituted acyclic branched alkene or unsubstituted acyclic unbranched alkene having one or two double bonds and from 6 to 12 carbon atoms. In some embodiments, the solvent blend comprises an unsubstituted acyclic branched alkene or unsubstituted acyclic unbranched alkene having one or two double bonds and from 6 to 10 carbon atoms. Non-limiting examples of unsubstituted acyclic unbranched alkenes having one or two double bonds and from 6 to 12 carbon atoms include isomers of hexene (e.g., 1-hexene, 2-hexene), isomers of hexadiene (e.g., 1,3-hexadiene, 1,4-hexadiene), isomers of heptene (e.g., 1-heptene, 2-heptene, 3-heptene), isomers of heptadiene (e.g., 1,5-heptadiene, 1-6, heptadiene), isomers of octene (e.g., 1-octene, 2-octene, 3-octene), isomers of octadiene (e.g., 1,7-octadiene), isomers of nonene, isomers of nonadiene, isomers of decene, isomers of decadiene, isomers of undecene, isomers of undecadiene, isomers of dodecene, isomers of dodecadiene, and combinations thereof. In some embodiments, the acyclic, unbranched alkene having one or two double bonds and from 6 to 12 carbon atoms is an alpha-olefin (e.g., 1-hexene, 1-heptene, 1-octene, 1-nonene, 1-decene, 1-undecene, 1-dodecene). Non-limiting examples of unsubstituted, acyclic, branched alkenes include isomers of methylpentene, isomers of dimethylpentene, isomers of ethylpentene, isomers of methylethylpentene, isomers of propylpentene, isomers of methylhexene, isomers of ethylhexene, isomers of dimethylhexene, isomers of methylethylhexene, isomers of methylheptene, isomers of ethylheptene, isomers of dimethylhexptene, isomers of methylethylheptene, and combinations thereof. In a some embodiments, the unsubstituted, acyclic, unbranched alkene having one or two double bonds and from 6 to 12 carbon atoms is 1-octene, 1,7-octadiene, or a combination thereof.

Additional Aromatic Solvents

In some embodiments, the solvent blend comprises an aromatic solvent having a boiling point from about 300 to about 400 degrees Fahrenheit. Non-limiting examples of aromatic solvents having a boiling point from about 300 to about 400 degrees Fahrenheit include butylbenzene, hexylbenzene, mesitylene, light aromatic naphtha, heavy aromatic naphtha, and combinations thereof.

In some embodiments, the solvent blend comprises an aromatic solvent having a boiling point from about 175 to about 300 degrees Fahrenheit. Non-limiting examples of aromatic liquid solvents having a boiling point from about 175 to about 300 degrees Fahrenheit include benzene, xylenes, and toluene. In a particular embodiment, the solvent blend does not comprise toluene or benzene.

Dialkyl Ethers

In some embodiments, the solvent blend comprises a branched or unbranched dialkylether having the formula CₙH₂ₙ₊₁OCₘH₂ₘ₊₁ wherein n+m is from 6 to 16. In some embodiments, n+m is from 6 to 12, or from 6 to 10, or from 6 to 8. Non-limiting examples of branched or unbranched dialkylether compounds having the formula CₙH₂ₙ₊₁OCₘH₂ₘ₊₁ include isomers of C₃H₇OC₃H₇, isomers of C₄H₉OC₃H₇, isomers of C₅H₁₁OC₃H₇, isomers of C₆H₁₃OC₃H₇, isomers of C₄H₉OC₄H₉, isomers of C₄H₉₀C₅H₁₁, isomers of C₄H₉OC₆H₁₃, isomers of C₅H₁₁OC₆H₃, and isomers of C₆H₁₃OC₆H₁₃. In a particular embodiment, the branched or unbranched dialklyether is an isomer of C₆H₁₃OC₆H₁₃ (e.g., dihexylether).

Bicyclic Hydrocarbon Solvents

In some embodiments, the solvent blend comprises a bicyclic hydrocarbon solvent with varying degrees of unsaturation including fused, bridgehead, and spirocyclic compounds. Non-limiting examples of bicyclic hydrocarbon solvents include isomers of decalin, tetrahydronapthalene, norbornane, norbornene, bicyclo[4.2.0]octane, bicyclo[3.2.1]octane, spiro[5.5]dodecane, and combinations thereof.

In some embodiments, the solvent blend comprises a bicyclic hydrocarbon solvent with varying degrees of unsaturation and containing at least one O, N, or S atom including fused, bridgehead, and spirocyclic compounds. Non-limiting examples include isomers of 7 oxabicyclo[2.2.1]heptane, 4,7-epoxyisobenzofuran-1,3-dione, 7 oxabicyclo[2.2.1]heptane-2,3-dicarboxylic acid, 2,3-dimethyl ester, and combinations thereof.

Alcohols

Alcohols contain one or more hydroxyl functional groups attached to substituted or unsubstituted alkane, alkene, or alkyne hydrocarbon chain. In some embodiments, the solvent blend comprises a cyclic or acyclic, branched or unbranched alkane, alkene or alkyne having from 6 to 12 carbon atoms and substituted with a hydroxyl group. Non-limiting examples of cyclic or acyclic, branched or unbranched alkanes having from 6 to 12 carbon atoms and substituted with a hydroxyl group include isomers of nonanol, isomers of decanol, isomers of undecanol, isomers of dodecanol, and combinations thereof. In a particular embodiment, the cyclic or acyclic, branched or unbranched alkane having from 9 to 12 carbon atoms and substituted with a hydroxyl group is I-nonanol, 1-decanol, or a combination thereof.

Non-limiting examples of cyclic or acyclic, branched or unbranched alkanes having 8 carbon atoms and substituted with a hydroxyl group include isomers of octanol (e.g., 1-octanol, 2-octanol, 3-octanol, 4-octanol), isomers of methyl heptanol, isomers of ethylhexanol (e.g., 2-ethyl-1-hexanol, 3-ethyl-1-hexanol, 4-ethyl-1-hexanol), isomers of dimethylhexanol, isomers of propylpentanol, isomers of methylethylpentanol, isomers of trimethylpentanol, and combinations thereof. In a particular embodiment, the cyclic or acyclic, branched or unbranched alkane having 8 carbon atoms and substituted with a hydroxyl group is 1-octanol, 2-ethyl-1-hexanol, or a combination thereof.

Amine Solvents

In some embodiments, the solvent blend comprises an amine of the formula NR¹R²R³, wherein R¹, R², and R³ are the same or different and are C₁₋₁₆ alkyl groups that are (i) branched or unbranched; (ii) cyclic or acyclic; and (iii) substituted or unsubstituted. In some embodiments any two of R¹, R², and R³ are joined together to form a ring. In some embodiments, each of R¹, R², and R³ are the same or different and are hydrogen or alkyl groups that are (i) branched or unbranched; (ii) cyclic or acyclic; and (iii) substituted or unsubstituted. In some embodiments, any two of R¹, R², and R³ are joined together to form a ring, provided at least one of R¹, R², and R³ is a methyl or an ethyl group. In some embodiments, R¹ is C₁-C₆ alkyl group that is (i) branched or unbranched; (ii) cyclic or acyclic; and (iii) substituted or unsubstituted and R² and R³ are hydrogen or a C₈₋₁₆ alkyl group that is (i) branched or unbranched; (ii) cyclic or acyclic; and (iii) substituted or unsubstituted. In some embodiments, R² and R³ may be joined together to form a ring. In some embodiments, R¹ is a methyl or an ethyl group and R² and R³ are the same or different and are C₈₋₁₆ alkyl groups that are (i) branched or unbranched; (ii) cyclic or acyclic; and (iii) substituted or unsubstituted. In some embodiments R² and R³ may be joined together to form a ring. In some embodiments, R¹ is a methyl group and R² and R³ are the same or different and are hydrogen or C₈₋₁₆ alkyl groups that are (i) branched or unbranched; (ii) cyclic or acyclic; and (iii) substituted or unsubstituted. In some embodiments R² and R³ may be joined together to form a ring. In some embodiments, R¹ and R² are the same or different and are hydrogen or C₁-C₆ alkyl groups that are (i) branched or unbranched; (ii) cyclic or acyclic; and (iii) substituted or unsubstituted and R³ is a C₈₋₁₆ alkyl group that is (i) branched or unbranched; (ii) cyclic or acyclic; and (iii) substituted or unsubstituted. In some embodiments, R¹ and R² are the same or different and are a methyl or an ethyl group and R³ is hydrogen or a C₈₋₁₆ alkyl group that is (i) branched or unbranched; (ii) cyclic or acyclic; and (iii) substituted or unsubstituted. In some embodiments, R¹ and R² are methyl groups and R³ is hydrogen or a C₈₋₁₆ alkyl group that is (i) branched or unbranched; (ii) cyclic or acyclic; and (iii) substituted or unsubstituted.

In some embodiments, the amine is of the formula NR¹R²R³, wherein R¹ is methyl and R² and R³ are C₈₋₁₆ alkyl groups that are (i) branched or unbranched; (ii) cyclic or acyclic; and (iii) substituted or unsubstituted. In some embodiments R² and R³ are joined together to form a ring. Non-limiting examples of amines include isomers of N-methyl-octylamine, isomers of N-methyl-nonylamine, isomers of N-methyl-decylamine, isomers of N-methylundecylamine, isomers of N-methyldodecylamine, isomers of N-methyl teradecylamine, isomers of N-methyl-hexadecylamine, and combinations thereof. In some embodiments, the amine is N-methyl-decylamine, N-methyl-hexadecylamine, or a combination thereof.

In some embodiments, the amine is of the formula NR¹R²R³, wherein R¹ is a methyl group and R² and R³ are the same or different and are C₈₋₁₆ alkyl groups that are (i) branched or unbranched; (ii) cyclic or acyclic; and (iii) substituted or unsubstituted. In some embodiments R² and R³ are joined together to form a ring. Non-limiting examples of amines include isomers of N-methyl-N-octyloctylamine, isomers of N-methyl-N-nonylnonylamine, isomers of N-methyl-N-decyldecylamine, isomers of N-methyl-N-undecylundecylamine, isomers of N-methyl-N-dodecyldodecylamine, isomers of N-methyl-N-tetradecylteradecylamine, isomers of N-methyl-N-hexadecylhexadecylamine, isomers of N-methyl-N-octylnonylamine, isomers of N-methyl-N-octyldecylamine, isomers of N-methyl-N-octyldodecylamine, isomers of N-methyl-N-octylundecylamine, isomers of N-methyl-N-octyltetradecylamine, isomers of N-methyl-N-octylhexadecylamine, N-methyl-N-nonyldecylamine, isomers of N-methyl-N-nonyldodecylamine, isomers of N-methyl-N-nonyltetradecylamine, isomers of N-methyl-N-nonylhexadecylamine, isomers of N-methyl-N-decylundecylamine, isomers of N-methyl-N-decyldodecylamine, isomers of N-methyl-N-decyltetradecylamine, isomers of N-methyl-N-decylhexadecylamine, isomers of N-methyl-N-dodecylundecylamine, isomers of N-methyl-N-dodecyltetradecylamine, isomers of N-methyl-N-dodecylhexadecylamine, isomers of N-methyl-N-tetradecylhexadecylamine, and combinations thereof. In some embodiments, the amine is selected from the group consisting of N-methyl-N-octyloctylamine, isomers of N-methyl-N-nonylnonylamine, isomers of N-methyl N-decyldecylamine, isomers of N-methyl-N-undecylundecylamine, isomers of N-methyl-N-dodecyldodecylamine, isomers of N-methyl-N-tetradecylteradecylamine, and isomers of N-methyl-N— hexadecylhexadecylamine, and combinations thereof. In some embodiments, the amine is N-methyl-N-dodecyldodecylamine, one or more isomers of N-methyl-N— hexadecylhexadecylamine, or combinations thereof. In some embodiments, the amine is selected from the group consisting of isomers of N-methyl-N-octylnonylamine, isomers of N-methyl-N-octyldecylamine, isomers of N-methyl-N-octyldodecylamine, isomers of N-methyl-N-octylundecylamine, isomers of N-methyl-N-octyltetradecylamine, isomers of N-methyl-N-octylhexadecylamine, N-methyl-N-nonyldecylamine, isomers of N-methyl-N-nonyldodecylamine, isomers of N-methyl-N-nonyltetradecylamine, isomers of N-methyl-N-nonylhexadecylamine, isomers of N-methyl-N-decyldodecylamine, isomers of N-methyl-N-decylundecylamine, isomers of N-methyl-N-decyldodecylamine, isomers of N-methyl-N-decyltetradecylamine, isomers of N-methyl-N-decylhexadecylamine, isomers of N-methyl-N-dodecylundecylamine, isomers of N-methyl-N-dodecyltetradecylamine, isomers of N-methyl-N-dodecylhexadecylamine, isomers of N-methyl-N-tetradecylhexadecylamine, and combinations thereof. In some embodiments, the cyclic or acyclic, branched or unbranched tri-substituted amine is selected from the group consisting of N-methyl-N-octyldodecylamine, N-methyl-N-octylhexadecylamine, and N-methyl-N-dodecylhexadecylamine, and combinations thereof.

In some embodiments, the amine is of the formula NR¹R²R³, wherein R¹ and R² are methyl and R³ is a C₈₋₁₆ alkyl that is (i) branched or unbranched; (ii) cyclic or acyclic; and (iii) substituted or unsubstituted. Non-limiting examples of amines include isomers of N,N-dimethylnonylamine, isomers of N,N-dimethyldecylamine, isomers of N,N-dimethylundecylamine, isomers of N,N-dimethyldodecylamine, isomers of N,N-dimethyltetradecylamine, and isomers of N,N-dimethylhexadecylamine. In some embodiments, the amine is selected from the group consisting of N,N-dimethyldecylamine, isomers of N,N-dodecylamine, and isomers of N,N-dimethylhexadecylamine.

Amide Solvents

In some embodiments, the solvent blend comprises an amide solvent. In some embodiments, the amide is of the formula N(C═OR⁴)R⁵R⁶, wherein R⁴, R⁵, and R⁶ are the same or different and are hydrogen or C₄₋₆ alkyl groups wherein the alkyl groups are (i) branched or unbranched; (ii) cyclic or acyclic; and (iii) substituted or unsubstituted. In some embodiments R⁵ and R⁶ are joined together to form a ring. In some embodiments, each of R⁴, R⁵, and R⁶ are the same or different and are hydrogen or C₄₋₁₆ alkyl groups wherein the alkyl groups are (i) branched or unbranched; (ii) cyclic or acyclic; and (iii) substituted or unsubstituted, provided at least one of R⁴, R⁵, and R⁶ is a methyl or an ethyl group. In some embodiments R⁵ and R⁶ are joined together to form a ring. In some embodiments, R⁴ is hydrogen, C₁-C₆ alkyl, wherein the alkyl group is (i) branched or unbranched; (ii)cyclic or acyclic; and (iii) substituted or unsubstituted, and R⁵ and R⁶ are the same or different and are hydrogen or C₈₋₁₆ alkyl groups wherein the alkyl groups are (i) branched or unbranched; (ii) cyclic or acyclic; and (iii) substituted or unsubstituted. In some embodiments R⁵ and R⁶ are joined together to form a ring. In some embodiments, R⁴ is hydrogen, methyl, or ethyl and R⁵ and R⁶ are C₈₋₁₆ alkyl groups wherein the alkyl groups are (i) branched or unbranched; (ii) cyclic or acyclic; and (iii) substituted or unsubstituted. In some embodiments R⁵ and R⁶ are joined together to form a ring. In some embodiments, R⁴ is hydrogen and R⁵ and R⁶ are the same or different and are C₈₋₁₆ alkyl groups wherein the alkyl groups are (i) branched or unbranched; (ii) cyclic or acyclic; and (iii) substituted or unsubstituted. In some embodiments R⁵ and R⁶ are joined together to form a ring. In some embodiments, R⁴ and R⁵ are the same or different and are hydrogen or C₁-C₆ alkyl groups wherein the alkyl groups are (i) branched or unbranched; (ii) cyclic or acyclic; and (iii) substituted or unsubstituted and R⁶ is a C₈₋₁₆ alkyl group that is (i) branched or unbranched; (ii) cyclic or acyclic; and (iii) substituted or unsubstituted. In some embodiments, R⁴ and R⁵ are the same or different and are independently hydrogen, methyl, or ethyl and R⁶ is a C₈₋₁₆ alkyl group that is (i) branched or unbranched; (ii) cyclic or acyclic; and (iii) substituted or unsubstituted. In some embodiments, R⁴ and R⁵ are hydrogen and R⁶ is a C₈₋₁₆ alkyl group that is (i) branched or unbranched; (ii) cyclic or acyclic; and (iii) substituted or unsubstituted. In some embodiments, R⁶ is hydrogen or R⁶ is a C₁₋₆ alkyl group that is (i) branched or unbranched; (ii) cyclic or acyclic; and (iii) substituted or unsubstituted and R⁴ and R⁵ are the same or different and are C₈₋₁₆ alkyl groups wherein the alkyl groups are (i) branched or unbranched; (ii) cyclic or acyclic; and (iii) substituted or unsubstituted. In some embodiments, R⁶ is hydrogen, methyl, or ethyl and R⁴ and R⁵ are the same or different and are C₈₋₁₆ alkyl groups wherein the alkyl groups are (i) branched or unbranched; (ii) cyclic or acyclic; and (iii) substituted or unsubstituted. In some embodiments, R⁶ is hydrogen and R⁴ and R⁵ are the same or different and are C₈₋₁₆ alkyl groups wherein the alkyl groups are (i) branched or unbranched; (ii) cyclic or acyclic; and (iii) substituted or unsubstituted. In some embodiments, R⁵ and R⁶ are the same or different and are hydrogen or C₁₋₆ alkyl groups wherein the alkyl groups are (i) branched or unbranched; (ii) cyclic or acyclic; and (iii) substituted or unsubstituted, and R⁴ is a C₈₋₁₆ alkyl group that is (i) branched or unbranched; (ii) cyclic or acyclic; and (iii) substituted or unsubstituted. In some embodiments, R⁵ and R⁶ are the same or different and are independently hydrogen, methyl, or ethyl and R⁴ is a C₈₋₁₆ alkyl group that is (i) branched or unbranched; (ii) cyclic or acyclic; and (iii) substituted or unsubstituted. In some embodiments, R⁵ and R⁶ are hydrogen and R⁴ is a C₈₋₁₆ alkyl group that is (i) branched or unbranched; (ii) cyclic or acyclic; and (iii) substituted or unsubstituted.

In some embodiments, the amide is of the formula N(C═OR⁴)R⁵R⁶, wherein each of R⁴, R⁵, and R⁶ are the same or different and are C₄₋₁₆ alkyl groups wherein the alkyl groups are (i) branched or unbranched; (ii) cyclic or acyclic; and (iii) substituted or unsubstituted. In some embodiments R⁵ and R⁶ are joined together to form a ring. In some embodiments, the amide is of the formula N(C═O R⁴)R⁵R⁶, wherein each of R⁴, R⁵, and R⁶ are the same or different and are C₈₋₁₆ alkyl groups wherein the alkyl groups are (i) branched or unbranched; (ii) cyclic or acyclic; and (iii) substituted or unsubstituted. In some embodiments R⁵ and R⁶ are joined together to form a ring. Non-limiting examples of amides include N,N-dioctyloctamide, N,N-dinonylnonamide, N,N-didecyldecamide, N,N-didodecyldodecamide, N,N-diundecylundecamide, N,N-ditetradecyltetradecamide, N,N-dihexadecylhexadecamide, N,N-didecyloctamide, N,N-didodecyloctamide, N,N-dioctyldodecamide, N,N-didecyldodecamide, N,N-dioctylhexadecamide, N,N-didecylhexadecamide, N,N-didodecylhexadecamide, and combinations thereof. In some embodiments, the amide is N,N-dioctyldodecamide, N,N-didodecyloctamide, or a combination thereof.

In some embodiments, the amide is of the formula N(C═OR⁴)R⁵R⁶, wherein R⁶ is selected from the group consisting of hydrogen, methyl, ethyl, propyl and isopropyl, and R⁴ and R⁵ are the same or different and are C₄₋₁₆ alkyl groups wherein the alkyl groups are (i) branched or unbranched; (ii) cyclic or acyclic; and (iii) substituted or unsubstituted. In some embodiments, R⁶ is selected from the group consisting of hydrogen, methyl, ethyl, propyl and isopropyl, and R⁴ and R⁵ are the same or different and are C₄₋₈ alkyl groups wherein the alkyl groups are (i) branched or unbranched; (ii) cyclic or acyclic; and (iii) substituted or unsubstituted. In some embodiments, at least one of R⁴ and R⁵ is substituted with a hydroxyl group. In some embodiments, at least one of R⁴ and R⁵ is C₁₋₁₆ alkyl substituted with a hydroxyl group.

In some embodiments, the amide is of the formula N(C═OR⁴)R⁵R⁶, wherein R⁶ is C₁-C₃ alkyl and R⁴ and R⁵ are the same or different and are C₄₋₁₆ alkyl groups that are (i) branched or unbranched; (ii) cyclic or acyclic; and (iii) substituted or unsubstituted. In some embodiments, R⁶ is selected from the group consisting of methyl, ethyl, propyl, and isopropyl, and R⁴ and R⁵ are the same or different and are C₄₋₁₆ alkyl groups that are (i) branched or unbranched; (ii) cyclic or acyclic; and (iii) substituted or unsubstituted. In some embodiments, R⁶ is selected from the group consisting of methyl, ethyl, propyl, and isopropyl, and R⁴ and R⁵ are the same or different and are C₈₋₁₆ alkyl groups that are (i) branched or unbranched; (ii) cyclic or acyclic; and (iii) substituted or unsubstituted. In some embodiments, at least one of R⁴ and R⁵ is substituted with a hydroxyl group. In some embodiments, R⁶ is selected from the group consisting of methyl, ethyl, propyl, and isopropyl, and R⁴ and R⁵ are the same or different and are C₄₋₁₆ alkyl groups that are (i) branched or unbranched; (ii) cyclic or acyclic; and (iii) substituted or unsubstituted. In some embodiments at least one of R⁴ and R⁵ is C₁₋₁₆ alkyl substituted with a hydroxyl group.

Non-limiting examples of amides include N,N-di-tert-butylformamide, N,N-dipentylformamide, N,N-dihexylformamide, N,N-diheptylformamide, N,N-dioctylformamide, N,N-dinonylformamide, N,N-didecylformamide, N,N-diundecylformamide, N,N-didodecylformamide, N,N-dihydroxymethylformamide, N,N-di-tert-butylacctamide, N,N-dipentylacctamide, N,N-dihexylacetamide, N,N-diheptylacetamide, N,N-dioctylacetamide, N,N-dinonylacetamide, N,N-didecylacetamide, N,N-diundecylacetamide, N,N-didodecylacetamide, N,N-dihydroxymethylacetamide, N,N-dimethylpropionamide, N,N-diethylpropionamide, N,N-dipropylpropionamide, N,N-di-n-propylpropionamide N,N-diisopropylpropionamide, N,N-dibutylpropionamide, N,N-di-n-butylpropionamide, N,N-di-sec-butylpropionamide, N,N-diisobutylpropionamide or N,N-di-tert-butylpropionamide, N,N-dipentylpropionamide, N,N-dihexylpropionamide, N,N-diheptylpropionamide, N,N-dioctylpropionamide, N,N-dinonylpropionamide, N,N-didecylpropionamide, N,N-diundecylpropionamide, N,N-didodecylpropionamide, N,N-dimethyl-n-butyramide, N,N-diethyl-n-butyramide, N,N-dipropyl-n-butyramide, N,N-di-n-propyl-n-butyramide or N,N-diisopropyl-n-butyramide, N,N-dibutyl-n-butyramide, N,N-di-n-butyl-n-butyramide, N,N-di-sec-butyl-n-butyramide, N,N-diisobutyl-n-butyramide, N,N-di-tert-butyl-n-butyramide, N,N-dipentyl-n-butyramide, N,N-dihexyl-n-butyramide, N,N-diheptyl-n-butyramide, N,N-dioctyl-n-butyramide, N,N-dinonyl-n-butyramide, N,N-didecyl-n-butyramide, N,N-diundecyl-n-butyramide, N,N-didodecyl-n-butyramide, N,N-dipentylisobutyramide, N,N-dihexylisobutyramide, N,N-diheptylisobutyramide, N,N-dioctylisobutyramide, N,N-dinonylisobutyramide, N,N-didecylisobutyramide, N,N-diundecylisobutyramide, N,N-didodecylisobutyramide, N,N-pentylhexylformamide, N,N-pentylhexylacetamide, N,N-pentylhexylpropionamide, N,N-pentylhexyl-n-butyramide, N,N-pentylhexylisobutyramide, N,N-methylethylpropionamide, N,N-methyl-n-propylpropionamide, N,N-methylisopropylpropionamide, N,N-methyl-n-butylpropionamide, N,N-methylethyl-n-butyramide, N,N-methyl-n-butyramide, N,N-methylisopropyl-n-butyramide, N,N-methyl-n-butyl-n-butyramide, N,N-methylethylisobutyramide, N,N-methyl-n-propylisobutyramide, N,N-methylisopropylisobutyramide, and N,N-methyl-n-butylisobutyramide. In some embodiments, the amide is selected from the group consisting of N,N-dioctyldodecacetamide, N,N-methyl-N-octylhexadecdidodecylacetamide, N-methyl-N-hexadecyldodecylhexadecacetamide, and combinations thereof.

In some embodiments, the amide is of the formula N(C═OR⁴)R⁵R⁶, wherein R⁶ is hydrogen or a methyl group and R⁴ and R⁵ are C₈₋₁₆ alkyl groups that are (i) branched or unbranched; (ii) cyclic or acyclic; and (iii) substituted or unsubstituted. Non-limiting amides include isomers of N-methyloctamide, isomers of N-methylnonamide, isomers of N-methyldecamide, isomers of N-methylundecamide, isomers of N methyldodecamide, isomers of N methylteradecamide, and isomers of N-methyl-hexadecamide. In some embodiments, the amides are selected from the group consisting of N-methyloctamide, N-methyldodecamide, N-methylhexadecamide, and combinations thereof.

Non-limiting amides include isomers of N-methyl-N-octyloctamide, isomers of N-methyl-N-nonylnonamide, isomers of N-methyl-N-decyldecamide, isomers of N methyl-N undecylundecamide, isomers of N methyl-N-dodecyldodecamide, isomers of N methyl N-tetradecylteradecamide, isomers of N-methyl-N-hexadecylhdexadecamide, isomers of N-methyl-N-octylnonamide, isomers of N-methyl-N-octyldecamide, isomers of N-methyl-N-octyldodecamide, isomers of N-methyl-N-octylundecamide, isomers of N-methyl-N-octyltetradecamide, isomers of N-methyl-N-octylhexadecamide, N-methyl-N-nonyldecamide, isomers of N-methyl-N-nonyldodecamide, isomers of N-methyl-N-nonyltetradecamide, isomers of N-methyl-N-nonylhexadecamide, isomers of N-methyl-N-decyldodecamide, isomers of N methyl-N-decylundecamide, isomers of N-methyl-N-decyldodecamide, isomers of N-methyl-N-decyltetradecamide, isomers of N-methyl-N-decylhexadecamide, isomers of N methyl-N-dodecylundecamide, isomers of N methyl-N-dodecyltetradecamide, isomers of N-methyl-N-dodecylhexadecamide, isomers of N methyl-N-tetradecylhexadecamide, and combinations thereof. In some embodiments, the amide is selected from the group consisting of isomers of N-methyl-N-octyloctamide, isomers of N-methyl-N-nonylnonamide, isomers of N-methyl-N-decyldecamide, isomers of N methyl-N undecylundecamide, isomers of N methyl-N-dodecyldodecamide, isomers of N methyl N-tetradecylteradecamide, isomers of N-methyl-N-hexadecylhdexadecamide, and combinations thereof. In some embodiments, amide is selected from the group consisting of N-methyl-N-octyloctamide, N methyl-N-dodecyldodecamide, and N-methyl-N-hexadecylhexadecamide. In some embodiments, the amide is selected from the group consisting of isomers of N-methyl-N-octylnonamide, isomers of N-methyl-N-octyldecamide, isomers of N-methyl-N-octyldodecamide, isomers of N-methyl-N-octylundecamide, isomers of N-methyl-N-octyltetradecamide, isomers of N-methyl-N-octylhexadecamide, N-methyl-N-nonyldecamide, isomers of N-methyl-N-nonyldodecamide, isomers of N-methyl-N-nonyltetradecamide, isomers of N-methyl-N-nonylhexadecamide, isomers of N-methyl-N-decyldodecamide, isomers of N methyl-N-decylundecamide, isomers of N-methyl-N-decyldodecamide, isomers of N-methyl-N-decyltetradecamide, isomers of N-methyl-N-decylhexadecamide, isomers of N methyl-N-dodecylundecamide, isomers of N methyl-N-dodecyltetradecamide, isomers of N-methyl-N-dodecylhexadecamide, and isomers of N methyl-N-tetradecylhexadecamide. In some embodiments, the amide is selected from the group consisting of N-methyl-N-octyldodecamide, N-methyl-N-octylhexadecamide, and N-methyl-N-dodecylhexadecamide.

In some embodiments, the amide is of the formula N(C═OR⁴)R⁵R⁶, wherein R⁵ and R⁶ are the same or different and are hydrogen or C₁-C₃ alkyl groups and R⁴ is a C₄₋₁₆ alkyl group that is (i) branched or unbranched; (ii) cyclic or acyclic; and (iii) substituted or unsubstituted. In some embodiments, R⁵ and R⁶ are the same or different and are selected from the group consisting of hydrogen, methyl, ethyl, propyl and isopropyl, and R⁴ is a C₄₋₁₆ alkyl group that is (i) branched or unbranched; (ii) cyclic or acyclic; and (iii) substituted or unsubstituted. In some embodiments, R⁵ and R⁶ are the same or different and are selected from the group consisting of hydrogen, methyl, ethyl, propyl and isopropyl and R⁴ is a C₈₋₁₆ alkyl group that is (i) branched or unbranched; (ii) cyclic or acyclic; and (iii) substituted or unsubstituted. In some embodiments, R⁴ is substituted with a hydroxyl group. In some embodiments, R⁵ and R⁶ are the same or different and are selected from the group consisting of hydrogen, methyl, ethyl, propyl, and isopropyl, and R⁴ is selected from the group consisting of tert-butyl and C₅₋₁₆ alkyl groups that are (i) branched or unbranched; (ii) cyclic or acyclic; and (iii) substituted or unsubstituted, and C₁₋₁₆ alkyl groups that are (i) branched or unbranched; (ii) cyclic or acyclic; and (iii) substituted with a hydroxyl group.

In some embodiments, the amide is of the formula N(C═OR⁴)R⁵R⁶, wherein R⁵ and R⁶ are methyl groups and R⁴ is a C₁₋₁₆ alkyl group that is (i) branched or unbranched; (ii) cyclic or acyclic; and (iii) substituted or unsubstituted. Non-limiting examples of amides include isomers of N,N-dimethyloctamide, isomers of N,N-dimethylnonamide, isomers of N,N-dimethyldecamide, isomers of N,N-dimethylundecamide, isomers of N,N-dimethyldodecamide, isomers of N,N-dimethyltetradecamide, isomers of N,N-dimethylhexadecamide, and combinations thereof. In some embodiments, the cyclic or acyclic, branched or unbranched tri-substituted amines is selected from the group consisting of N,N-dimethyloctamide, N,N-dodecamide, and N,N-dimethylhexadecamide.

Silicone Solvents

In some embodiments, the solvent blend in the composition comprises a methyl siloxane solvent. The composition may comprise a single methyl siloxane solvent or a combination of two or more methyl siloxane solvents. Methyl siloxane solvents may be classified as linear, cyclic, or branched. Methyl siloxane solvents are a class of oligomeric liquid silicones that possess the characteristics of low viscosity and high volatility. Non-limiting examples of linear siloxane solvents include hexamethyldisiloxane, octamethyltrisiloxane, decamethyltetrasiloxane, and dodecamethylpentasiloxane. Non-limiting examples of cyclic siloxane solvents include octamethylcyclotetrasiloxane, decamethylcyclopentasiloxane, and dodecamethylcyclohexasiloxane.

In some embodiments the siloxane solvent comprises a first type of siloxane solvent and a second type of siloxane solvent.

In some embodiments, the siloxanes are linear methyl siloxanes, cyclic methyl siloxanes, branched methyl siloxanes, and combinations thereof. The linear methyl siloxanes have the formula

(CH₃)₃SiO{(CH₃)₂SiO}ₖSi(CH₃)₃

wherein the value of k is 0-5. The cyclic methyl siloxanes have the formula

{(CH₃)₂SiO}ₜ

wherein the value oft is 3-6. Preferably, these methyl siloxanes have a boiling point less than about 250° C. and viscosity of about 0.65 to about 5.0 cSt.

Some representative linear methyl siloxanes are hexamethyldisiloxane with a boiling point of 100 degrees Celsius, viscosity of 0.65 cSt, and structure

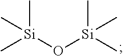

octamethyltrisiloxane with a boiling point of 152 degrees Celsius, viscosity of 1.04 cSt, and structure

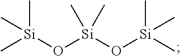

decamethyltetrasiloxane with a boiling point of 194 degrees Celsius, viscosity of 1.53 cSt, and structure

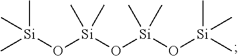

dodecamethylpentasiloxane with a boiling point of 229 degrees Celsius, viscosity of 2.06 cSt, and structure

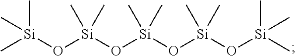

tetradecamethylhexasiloxane with a boiling point of 245 degrees Celsius, viscosity of 2.63 cSt, and structure

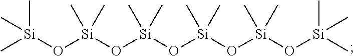

and hexadecamethylheptasiloxane with a boiling point of 270 degrees Celsius, viscosity of 3.24 cSt, and structure

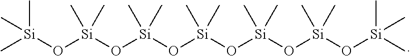

Some representative cyclic methyl siloxanes are hexamethylcyclotrisiloxane with a boiling point of 134 degrees Celsius and structure

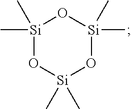

octamethylcyclotetrasiloxane with a boiling point of 176 degrees Celsius, viscosity of 2.3 cSt, and structure

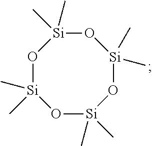

decamethylcyclopentasiloxane with a boiling point of 210 degrees Celsius, viscosity of 3.87 cSt, and structure

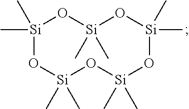

and dodecamethylcyclohexasiloxane with a boiling point of 245 degrees Celsius, viscosity of 6.62 cSt, and structure

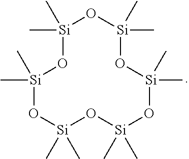

In some embodiments, a solvent (e.g., a terpene) may be extracted from a natural source (e.g., citrus, pine), and may comprise one or more impurities present from the extraction process. In some embodiments, the solvent comprises a crude cut (e.g., uncut crude oil, e.g., made by settling, separation, heating, etc.). In some embodiments, the solvent is a crude oil (e.g., naturally occurring crude oil, uncut crude oil, crude oil extracted from the wellbore, synthetic crude oil, crude citrus oil, crude pine oil, eucalyptus, etc.). In some embodiments, the solvent comprises a citrus extract (e.g., crude orange oil, orange oil, etc.). In some embodiments, the solvent is a citrus extract (e.g., crude orange oil, orange oil, etc.).

In some embodiments, the non-aqueous solvent blend may further comprise a third type of solvent. Non-limiting examples of the third type of solvent include plant-based methyl esters (e.g. soy methyl ester, canola methyl ester), alcohols, amides, and hydrocarbons, or combinations thereof. In some embodiments, the third type of solvent is an alkyl aliphatic ester solvent. In some embodiments, the alkyl aliphatic ester solvent is a methyl ester. In some embodiments, the third type of solvent is selected from the group consisting of soy methyl ester, canola methyl ester, octanoic acid methyl ester, decanoic acid methyl ester, dodecanoic acid methyl ester, palm methyl ester, and coconut methyl ester, or combinations thereof. In some embodiments, the third type of solvent is butyl 3-hydroxybutanoate. Without wishing to be bound by theory, the third type of solvent (e.g., alkyl aliphatic ester solvent) may serve as a coupling agent between the other components of the solvent blend and the one or more surfactant. In some embodiments, the third type of solvent may be an alcohol. In some embodiments, the alcohol is selected from the group consisting of primary, secondary, and tertiary alcohols having from 1 to 20 carbon atoms. Non-limiting examples of alcohols include methanol, ethanol, isopropanol, n-propanol, n-butanol, i-butanol, sec-butanol, iso-butanol, t-butanol, ethylene glycol, propylene glycol, dipropylene glycol monomethyl ether, triethylene glycol, and ethylene glycol monobutyl ether.

In some embodiments, the composition comprises an aqueous phase. Generally, the aqueous phase comprises water. The water may be provided from any suitable source (e.g., sea water, fresh water, deionized water, reverse osmosis water, water from field production). In some embodiments, the composition (e.g., emulsion or microemulsion) comprises from about 1 wt % to about 60 wt %, or from about 10 wt % to about 55 wt %, or from about 15 wt % to about 45 wt %, or from about 25 wt % to about 45 wt % of water, versus the total weight of the emulsion or microemulsion composition. The aqueous phase may comprise dissolved salts. Non-limiting examples of dissolved salts include salts comprising K, Na, Br, Cr, Cs, or Bi, for example, halides of these metals, including NaCl, KCl, CaCl₂, MgCl₂, and combinations thereof.

Surfactants

Generally, the composition comprises a surfactant. In some embodiments, the composition comprises a first surfactant and a second surfactant. In some embodiments, the composition comprises a first surfactant and a co-surfactant. In some embodiments, the composition comprises a first surfactant, a second surfactant and a co-surfactant. The term surfactant is given its ordinary meaning in the art and generally refers to compounds having an amphiphilic structure which gives them an affinity for oil/water type and water/oil type interfaces. In some embodiments, the affinity helps the surfactants to reduce the free energy of these interfaces and to stabilize the dispersed phase of an emulsion or microemulsion.

In some embodiments, the composition further comprises a surfactant. In some embodiments, the surfactant comprises a derivative of CNSL (e.g., an ethoxylated cashew nut shell liquid), a linear alcohol ethoxylate, or a combination thereof. The surfactant in some embodiments serves as a more environmentally friendly alternative to nonyl phenol ethoxylate.

Examples of surfactants include, but are not limited to nonionic surfactants, anionic surfactants, cationic surfactants, amphoteric surfactants, zwitterionic surfactants, switchable surfactants, cleavable surfactants, dimeric or gemini surfactants, glucamide surfactants, alkylpolyglycoside surfactants, extended surfactants containing a nonionic spacer arm central extension and an ionic or nonionic polar group, and combinations thereof. Nonionic surfactants generally do not contain any charges. Anionic surfactants generally possess a net negative charge. Cationic surfactants generally possess a net positive charge. Amphoteric surfactants generally have both positive and negative charges, however, the net charge of the surfactant can be positive, negative, or neutral, depending on the pH of the solution. Zwitterionic surfactants are generally not pH dependent. A zwitterion is a neutral molecule with a positive and a negative electrical charge, though multiple positive and negative charges can be present.

“Extended surfactants” are defined herein to be surfactants having propoxylated/ethoxylated spacer arms. The extended chain surfactants are intramolecular mixtures having at least one hydrophilic portion and at least one lipophilic portion with an intermediate polarity portion in between the hydrophilic portion and the lipophilic portion; the intermediate polarity portion may be referred to as a spacer. They attain high solubilization in the single phase emulsion or microemulsion, and are in some instances, insensitive to temperature and are useful for a wide variety of oil types, such as natural or synthetic polar oil types in a non-limiting embodiment. More information related to extended chain surfactants may be found in U.S. Pat. No. 8,235,120, which is herein incorporated by reference in its entirety.

The term co-surfactant as used herein, is given its ordinary meaning in the art and refers to compounds (e.g., pentanol) that act in conjunction with surfactants to form an emulsion or microemulsion.

In some embodiments, the one or more surfactants is a surfactant described in U.S. patent application Ser. No. 14/212,731, filed Mar. 14, 2014, entitled “METHODS AND COMPOSITIONS FOR USE IN OIL AND/OR GAS WELLS,” now published as US/2014/0284053 on Sep. 25, 2014, herein incorporated by reference. In some embodiments, the surfactant is a surfactant described in U.S. patent application Ser. No. 14/212,763, filed Mar. 14, 2014, entitled “METHODS AND COMPOSITIONS FOR USE IN OIL AND/OR GAS WELLS,” now published as US/2014/0338911 on Nov. 20, 2014, and granted as U.S. Pat. No. 9,884,988, herein incorporated by reference.

In some embodiments, the composition (e.g., emulsion or microemulsion) comprises from about 0.1 wt % to about 10 wt %, or from about 0.1 wt % to about 8 wt %, or from about 0.1 wt % to about 6 wt %, or from about 0.1 wt % to about 4 wt %, or from about 0.1 wt % to about 3 wt %, or from about 0.1 wt % to about 2 wt % of the one or more surfactants, versus the total weight of the composition.

In some embodiments, the composition comprises from about 1 wt % to about 50 wt %, or from about 1 wt % to about 40 wt %, or from about 1 wt % to about 35 wt %, or from about 5 wt % to about 40 wt %, or from about 5 wt % to about 35 wt %, or from about 10 wt % to about 30 wt % of the surfactant versus the total weight of the composition.

In some embodiments, the composition comprises from about 5 wt % to about 65 wt %, or from about 5 wt % to about 60 wt %, or from about 0.01 wt % to about 60 wt %, or from about 0.1 wt % to about 60 wt %, or from about 1 wt % to about 60 wt %, or from about 5 wt % to about 50 wt %, or from about 5 wt % to about 40 wt %, or from about 10 wt % to about 55 wt %, or from about 10 wt % to about 30 wt % of the surfactant, versus the total weight of the composition.

In some embodiments, the surfactants described herein in conjunction with solvents, generally form emulsions or microemulsions that may be diluted to a use concentration to form an oil-in-water nanodroplet dispersion. In some embodiments, the surfactants generally have hydrophile-lipophile balance values from 8 to 18, or from 8 to 14.

Hydrophilic Hydrocarbon Surfactants

Suitable surfactants for use with the compositions and methods are generally described herein. In some embodiments, the surfactant comprises a hydrophilic hydrocarbon surfactant. In some embodiments, the hydrophilic hydrocarbon surfactant comprises an alcohol ethoxylate, wherein the alcohol ethoxylate contains a hydrocarbon group of 10 to 18 carbon atoms and contains an ethoxylate group of 5 to 12 ethylene oxide units. In some embodiments, the composition may comprise a surfactant with a hydrophile lipophile balance (HLB) of greater than 7.

Nonionic Surfactants

In some embodiments, the surfactant comprises a nonionic surfactant. In some embodiments, the nonionic surfactant is an alkoxylated aliphatic alcohol having from 3 to 40 ethylene oxide (EO) units and from 0 to 20 propylene oxide (PO) units. The term aliphatic alcohol generally refers to a branched or linear, saturated or unsaturated aliphatic moiety having from 6 to 18 carbon atoms. In some embodiments, the alkoxylated aliphatic alcohol comprises alcohol ethoxylates. In some embodiments, the alcohol ethoxylate is a linear, C₁₂-C₁₅ alcohol ethoxylated with 7 moles of ethylene oxide. In some embodiments, the alcohol ethoxylate is a linear, C₁₂-C₁₅ alcohol ethoxylated with 9 moles of ethylene oxide.

In some embodiments, the surfactant is selected from the group consisting of ethoxylated fatty acids, ethoxylated fatty amines, and ethoxylated fatty amides wherein the fatty portion is a branched or linear, saturated or unsaturated aliphatic hydrocarbon moiety having from 6 to 18 carbon atoms.

In some embodiments, the surfactant is an alkoxylated castor oil. In some embodiments, the surfactant is an ethoxylated castor oil surfactant. In some embodiments, the surfactant is a sorbitan ester derivative. In some embodiments, the surfactant may comprise an ethylene oxide polymer, a propylene oxide polymer, and/or an ethylene oxide—propylene oxide copolymer. In some embodiments, the surfactant may be an ethoxylated castor oil surfactant comprising EO units, such as an ethoxylated castor oil surfactant comprising 40 EO units. In some embodiments the surfactant is an ethylene oxide—propylene oxide copolymer wherein the total number of EO and PO units is from 8 to 40 units. In some embodiments, the surfactant is an alkoxylated tristyryl phenol containing from 6 to 100 total ethylene oxide (EO) and propylene oxide (PO) units.

In some embodiments the surfactant is an ethoxylated CNSL surfactant. In some embodiments the surfactant is a blend of ethoxylated CNSL surfactants with different degrees of ethoxylation. A choice of specific suitable ethoxylated CNSL surfactants will be known to those skilled in the art.

In some embodiments, the surfactant is an amine-based surfactant selected from the group consisting of ethoxylated alkylene amines, ethoxylated alkyl amines, propoxylated alkylene amines, propoxylated alkyl amines, ethoxylated-propoxylated alkylene amines and ethoxylated propoxylated alkyl amines. The ethoxylated/propoxylated alkylene or alkyl amine surfactant component preferably includes more than one nitrogen atom per molecule. Suitable amines include ethylenediaminealkoxylate and diethylenetriaminealkoxylate. In some embodiments, the amine-based surfactants may be referred to as polyamine-based surfactants. For instance, in some embodiments the surfactant comprises an alkoxylated polyamine surfactant.

In some embodiments the surfactant comprises an alkoxylated polyamine surfactant with a relative solubility number (RSN) in the range of 5-20. As will be known to those of ordinary skill in the art, RSN values are generally determined by titrating water into a solution of surfactant in 1,4 dioxane. The RSN values is generally defined as the amount of distilled water necessary to be added to produce persistent turbidity. In some embodiments the surfactant is an alkoxylated novolac resin (also known as a phenolic resin) with a relative solubility number in the range of 5-20. In some embodiments the surfactant is a block copolymer surfactant with a total molecular weight greater than 5000 daltons. The block copolymer may have a hydrophobic block that is comprised of a polymer chain that is linear, branched, hyperbranched, dendritic or cyclic.

In some embodiments, the surfactant is selected from the group consisting of alkoxylated alkylphenols, alkoxylated dialkylphenols, alkoxylated trialkylphenols, and mixtures thereof. The alkoxylated portion of each of these surfactants may include polyethylene oxide, polypropylene oxide and mixtures thereof. The alkyl portion of each of these surfactants may include aliphatic hydrocarbon radicals containing between 1 to 8 carbon atoms

In some embodiments, the surfactant is tributylphenol ethoxylate with different degrees of ethoxylation. In some embodiments the degree of ethoxylation of the tributylphenol ethoxylate surfactant may be between 1 moles to 100 moles of ethylene oxide per mole of tributylphenol, preferably between 1 mole to 20 moles of ethylene oxide per mole of tributylphenol. In some embodiments, the tributylphenol surfactant is tri-2,4,6-sec-butylphenol ethoxylate with a degree of ethoxylation between 1 mole to 100 moles of ethylene oxide per mole of tri-2,4,6-sec-butylphenol, preferably 1 mole to 20 moles of ethylene oxide per mole of tri-2,4,6-sec-butylphenol. One example of a tributylphenol ethoxylate surfactant is Sapogant® T series available from Clariant International.

In some embodiments, the surfactant is a derivatized CNSL. In some embodiments, the derivatized CNSL is ethoxylated CNSL with different degrees of ethoxylation. In some embodiments, the degree of ethoxylation of the ethoxylated CNSL may be between 1 mole to 100 moles of ethylene oxide per mole of CNSL, preferably between 1 mole to 20 moles of ethylene oxide per mole of CNSL. Some examples of an ethoxylated CNSL is the line of Cardleox® products available from K2P Industries.

Glycosides and Glycamides

In some embodiments, the surfactant is an aliphatic polyglycoside having the following formula:

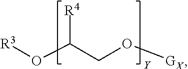

wherein R³ is an aliphatic group having from 6 to 18 carbon atoms; each R⁴ is independently selected from H, —CH₃, or —CH₂CH₃; Y is an average number of from about 0 to about 5; and X is an average degree of polymerization (DP) of from about 1 to about 4; G is the residue of a reducing saccharide, for example, a glucose residue. In some embodiments, Y is zero.

In some embodiments, the surfactant is an aliphatic glycamide having the following formula:

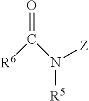

wherein R⁶ is an aliphatic group having from 6 to 18 carbon atoms; R⁵ is an alkyl group having from 1 to 6 carbon atoms; and Z is —CH₂(CH₂OH)_{b}CH₂OH, wherein b is from 3 to 5. In some embodiments, R⁵ is —CH₃. In some embodiments, R⁶ is an alkyl group having from 6 to 18 carbon atoms. In some embodiments, b is 3. In some embodiments, b is 4. In some embodiments, b is 5.

Anionic Surfactants

Suitable anionic surfactants include, but are not necessarily limited to, alkali metal alkyl sulfates, alkyl or alkylaryl sulfonates, linear or branched alkyl ether sulfates and sulfonates, alcohol polypropoxylated and/or polyethoxylated sulfates, alkyl or alkylaryl disulfonates, alkyl disulfates, alkyl sulphosuccinates, alkyl ether sulfates, linear and branched ether sulfates, fatty carboxylates, alkyl sarcosinates, alkyl phosphates and combinations thereof.

In some embodiments, the surfactant is an aliphatic sulfate wherein the aliphatic moiety is a branched or linear, saturated or unsaturated aliphatic hydrocarbon moiety having from 6 to 18 carbon atoms. In some embodiments, the surfactant is an aliphatic sulfonate wherein the aliphatic moiety is a branched or linear, saturated or unsaturated aliphatic hydrocarbon moiety having from 6 to 18 carbon atoms.

In some embodiments, the surfactant is an aliphatic alkoxy sulfate wherein the aliphatic moiety is a branched or linear, saturated or unsaturated aliphatic hydrocarbon moiety having from 6 to 18 carbon atoms and from 4 to 40 total ethylene oxide (EO) and propylene oxide (PO) units.

In some embodiments, the surfactant is an aliphatic-aromatic sulfate wherein the aliphatic moiety is a branched or linear, saturated or unsaturated aliphatic hydrocarbon moiety having from 6 to 18 carbon atoms. In some embodiments, the surfactant is an aliphatic-aromatic sulfonate wherein the aliphatic moiety is a branched or linear, saturated or unsaturated aliphatic hydrocarbon moiety having from 6 to 18 carbon atoms.

In some embodiments, the surfactant is an ester or half ester of sulfosuccinic acid with monohydric alcohols.

Cationic Surfactants

In some embodiments, the surfactant is a cationic surfactant such as, monoalkyl quaternary amines, such as coco trimethyl ammonium chloride, cetyl trimethyl ammonium chloride, stearyl trimethyl ammonium chloride, soya trimethyl ammonium chloride, behen trimethyl ammonium chloride, and the like and mixtures thereof. Other suitable cationic surfactants may include, but are not necessarily limited to, dialkylquaternary amines such as dicetyl dimethyl ammonium chloride, dicocodimethylammonium chloride, distearyl dimethyl ammonium chloride, and the like and mixtures thereof.

In some embodiments, the surfactant is an alkylbenzylammonium salt, whose alkyl groups have 1-24 carbon atoms (e.g., a halide, sulfate, phosphate, acetate, or hydroxide salt). In some embodiments, the surfactant is a quaternary alkylbenzylammonium salt, whose alkyl groups have 1-24 carbon atoms (e.g., a halide, sulfate, phosphate, acetate, or hydroxide salt). In some embodiments, the surfactant is an alkylpyridinium, an alkylimidazolinium, or an alkyloxazolinium salt whose alkyl chain has up to 18 carbons atoms (e.g., a halide, sulfate, phosphate, acetate, or hydroxide salt).

Zwitterionic and Amphoteric Surfactants

In some embodiments, the surfactant is amphoteric or zwitterionic, including to sultaines (e.g., cocamidopropyl hydroxysultaine), betaines (e.g., cocamidopropyl betaine), or phosphates (e.g., lecithin). In some embodiments, the surfactant is an amine oxide (e.g., dodecyldimethylamine oxide).

Hydrophilic Organosilicone Surfactants

in some embodiments, the surfactant comprises a hydrophilic organosilicone surfactant. In some embodiments, the surfactant comprises a mixture of a hydrophilic hydrocarbon surfactant and a hydrophilic organosilicone surfactant. Although the hydrophilic-lipophilic balance (HLB) system cannot strictly be applied to hydrophilic organosilicone surfactants, approximate HLB values for a hydrophilic organosilicone surfactant are from 8 to 18. In some embodiments, the hydrophilic organosilicone surfactant comprises one or more polyalkylene oxide groups containing from 4 to 40 total ethylene oxide (EO) and propylene oxide (PO) units. In some embodiments, the hydrophilic organosilicone surfactant comprises one or more polyethylene oxide groups containing from 4 to 12 ethylene oxide (EO) groups.

In some embodiments, the composition may comprise a single hydrophilic organosilicone surfactant or a combination of two or more hydrophilic organosilicone surfactants. For example, in some embodiments the hydrophilic organosilicone surfactant comprises a first type of hydrophilic organosilicone surfactant and a second type of hydrophilic organosilicone surfactant.

Non-limiting examples of hydrophilic organosilicone surfactants include polyalkyleneoxide-modified pentamethyldisiloxane, polyalkyleneoxide-modified heptamethyltrisiloxane, polyalkyleneoxide-modified nonamethyltetrasiloxane, polyalkyleneoxide-modified undecamethylpentasiloxane, polyalkyleneoxide-modified tridecamethylhexasiloxane and combinations thereof. The polyalkyleneoxide moiety may be end capped with —H, —CH₃, an acetoxy group, or an ethoxy group. The polyalkylene oxide group comprises polyethylene oxide, polypropyleneoxide, polybutyleneoxide, and combinations thereof.

In some embodiments, the hydrophilic organosilicone surfactant comprises methoxy-modified polyalkylene pentamethyldisiloxane, methoxy-modified polyalkylene heptamethyltrisiloxane, methoxy-modified polyalkylene nonamethyltetrasiloxane, methoxy-modified polyalkylene undecamethylpentasiloxane, polyalkylene methoxy-modified tridecamethylhexasiloxane, methoxy-modified polyalkyleneoxide-modified polydimethylsiloxane, ethoxy-modified polyalkylene pentamethyldisiloxane, ethoxy-modified polyalkylene heptamethyltrisiloxane, ethoxy-modified polyalkylene nonamethyltetrasiloxane, ethoxy-modified polyalkylene undecamethylpentasiloxane, ethoxy-modified polyalkylene tridecamethylhexasiloxane, ethoxy-modified polyalkyleneoxide-modified polydimethylsiloxane and combinations thereof.

In some embodiments the surfactant is an ethoxylated nonionic organosilicone surfactant. For example, the ethoxylated nonionic organosilicone surfactant may be a trisiloxane with an ethoxylate group having 4 to 12 ethylene oxide (EO) units. Non-limiting examples of such surfactants include trisiloxane surfactants with 7-8 EO units, Momentive® Silwet L-77®, Dow Corning Q2-5211 superwetting agent, and Dow Corning® Q2-5212 wetting agent.

In some embodiments, the composition (e.g., emulsion or microemulsion) further comprises a co-solvent. In some embodiments, the co-solvent is a mutual solvent. As used herein, mutual solvents are solvents which have an affinity to and are capable of dissolving both oil-soluble and water-soluble substances. Some non-limiting examples of mutual solvents include ethylene glycol monobutyl ether (EGMBE), dipropylene glycol monobutyl ether (DPGME), and isopropyl alcohol (isopropanol). In some embodiments, the co-solvent is an alcohol. The co-solvent (e.g., alcohol) may serve as a coupling agent between the solvent and the surfactant and/or may aid in the stabilization of the composition. The alcohol may also be a freezing point depression agent for the composition. That is, the alcohol may lower the freezing point of the composition. In some embodiments, the alcohol is selected from primary, secondary, and tertiary alcohols having from 1 to 20 carbon atoms.

In some embodiments, the co-solvent is selected from the group consisting of methanol, ethanol, isopropanol, n-propanol, n-butanol, i-butanol, sec-butanol, iso-butanol, t-butanol, ethylene glycol, propylene glycol, dipropylene glycol monomethyl ether, triethylene glycol, and ethylene glycol monobutyl ether.

In some embodiments, the composition comprises from about 1 wt % to about 50 wt %, or from about 1 wt % to about 40 wt %, or from about 1 wt % to about 35 wt %, or from about 5 wt % to about 40 wt %, or from about 5 wt % to about 35 wt %, or from about 10 wt % to about 30 wt % of the co-solvent (e.g., alcohol), versus the total weight of the composition.

Additives

In some embodiments, the composition may comprise one or more additives in addition to the components discussed above. In some embodiments, the one or more additional additives are present in an amount from about 0 wt % to about 70 wt %, from about 1 wt % to about 40 wt %, from about 0 wt % to about 30 wt %, from about 0.5 wt % to about 30 wt %, from about 1 wt % to about 30 wt %, from about 0 wt % to about 25 wt %, from about 1 wt % to about 25 wt %, from about 0 wt % to about 20 wt %, from about 1 wt % to about 20 wt %, from about 3 wt % to about 20 wt %, or from about 8 wt % to about 16 wt %, versus the total weight of the composition.

Non-limiting examples of additives include a demulsifier, a freezing point depression agent, a proppant, a scale inhibitor, a friction reducer, a biocide, a corrosion inhibitor, a buffer, a viscosifier, an oxygen scavenger, a clay control additive, a paraffin control additive, an asphaltene control additive, an acid, an acid precursor, or a salt.

Demulsifier

In some embodiments, the additive is a demulsifier. The demulsifier may aid in preventing the formulation of an emulsion between a treatment fluid and crude oil. Non-limiting examples of demulsifiers include polyoxyethylene (50) sorbitol hexaoleate. In some embodiments, the demulsifier is present in the composition in an amount from about 4 wt % to about 8 wt % versus the total weight of the composition.

Freezing Point Depression Agent

In some embodiments, the composition comprises a freezing point depression agent (e.g., propylene glycol). The composition may comprise a single freezing point depression agent or a combination of two or more freezing point depression agents. The term “freezing point depression agent” is given its ordinary meaning in the art and refers to a compound which is added to a solution to reduce the freezing point of the solution. That is, in some embodiments, a solution comprising the freezing point depression agent has a lower freezing point as compared to an essentially identical solution not comprising the freezing point depression agent. Those of ordinary skill in the art will be aware of suitable freezing point depression agents for use in the compositions described herein. Non-limiting examples of freezing point depression agents include primary, secondary, and tertiary alcohols with from 1 to 20 carbon atoms and alkylene glycols. In some embodiments, the alcohol comprises at least 2 carbon atoms. Non-limiting examples of alcohols include methanol, ethanol, i-propanol, n-propanol, t-butanol, n-butanol, n-pentanol, n-hexanol, and 2-ethyl hexanol. In some embodiments, the freezing point depression agent is not methanol (e.g., due to toxicity). Non-limiting examples of alkylene glycols include ethylene glycol (EG), polyethylene glycol (PEG), propylene glycol (PG), and triethylene glycol (TEG). In some embodiments, the freezing point depression agent is not ethylene oxide (e.g., due to toxicity). In some embodiments, the freezing point depression agent comprises an alcohol and an alkylene glycol. In some embodiments, the freezing point depression agent comprises a carboxycyclic acid salt and/or a di-carboxycylic acid salt. Another non-limiting example of a freezing point depression agent is a combination of choline chloride and urea. In some embodiments, the composition comprising the freezing point depression agent is stable over a wide range of temperatures, e.g., from about 50° F. to 200° F. In some embodiments, a freezing point depression agent is present in the composition in an amount from about 10 wt % to about 15 wt %.

Proppant

In some embodiments, the composition comprises a proppant. In some embodiments, the proppant acts to hold induced hydraulic fractures open in an oil and/or gas well. Non-limiting examples of proppants (e.g., propping agents) include grains of sand, glass beads, crystalline silica (e.g., quartz), hexamethylenetetramine, ceramic proppants (e.g., calcined clays), resin coated sands, and resin coated ceramic proppants. Other proppants are also possible and will be known to those skilled in the art.

Scale Inhibitor

In some embodiments, the composition comprises a scale inhibitor. The scale inhibitor may slow scaling in, e.g., the treatment of an oil and/or gas well, wherein scaling involves the unwanted deposition of solids (e.g., along a pipeline) that hinders fluid flow. Non-limiting examples of scale inhibitors include one or more of methyl alcohol, organic phosphonic acid salts (e.g., phosphonate salt, aminopolycarboxylic acid salts), polyacrylate, ethane-1,2-diol, calcium chloride, and sodium hydroxide. Other scale inhibitors are also possible and will be known to those skilled in the art.

Friction Reducer

In some embodiments, the composition comprises a friction reducer. The friction reducer may reduce drag, which reduces energy input required in the context of e.g. delivering the composition into a wellbore. Non-limiting examples of friction reducers include oil-external emulsions of polymers with oil-based solvents and an emulsion-stabilizing surfactant. The composition may include natural-based polymers like guar, cellulose, xanthan, proteins, polypeptides or derivatives of same or synthetic polymers like polyacrylamide-co-acrylic acid (PAM-AA), polyethylene oxide, polyacrylic acid, and other copolymers of acrylamide and other vinyl monomers. For a list of non-limiting examples, see U.S. Pat. No. 8,865,632, filed Nov. 10, 2008, entitled “DRAG-REDUCING COPOLYMER COMPOSITION,” herein incorporated by reference. Other common drag-reducing additives include dispersions of natural- or synthetic polymers and copolymers in saline solution and dry natural- or synthetic polymers and copolymers. These polymers or copolymers may be nonionic, zwitterionic, anionic, or cationic depending on the composition of polymer and pH of solution. Other non-limiting examples of friction reducers include petroleum distillates, ammonium salts, polyethoxylated alcohol surfactants, and anionic polyacrylamide copolymers. Other friction reducers are also possible and will be known to those skilled in the art.

Biocide

In some embodiments, the composition comprises a biocide. The biocide may kill unwanted organisms (e.g., microorganisms) that come into contact with the composition. Non-limiting examples of biocides include didecyl dimethyl ammonium chloride, gluteral, Dazomet, bronopol, tributyl tetradecyl phosphonium chloride, tetrakis (hydroxymethyl) phosphonium sulfate, AQUCAR®, UCARCIDE®, glutaraldehyde, sodium hypochlorite, and sodium hydroxide. Other biocides are also possible and will be known to those skilled in the art.

Corrosion Inhibitor

In some embodiments, the composition comprises a corrosion inhibitor. The corrosion inhibitor may reduce corrosion during e.g. treatment of an oil and/or gas well (e.g., in a metal pipeline). Non-limiting examples of corrosion inhibitors include isopropanol, quaternary ammonium compounds, thiourea/formaldehyde copolymers, propargyl alcohol, and methanol. Other corrosion inhibitors are also possible and will be known to those skilled in the art.

Buffer

In some embodiments, the composition comprises a buffer. The buffer may maintain the pH and/or reduce changes in the pH of the aqueous phase of the composition. Non-limiting examples of buffers include acetic acid, acetic anhydride, potassium hydroxide, sodium hydroxide, and sodium acetate. Other buffers are also possible and will be known to those skilled in the art.

Viscosifier

In some embodiments, the composition comprises a viscosifier. The viscosifier may increase the viscosity of the composition. Non-limiting examples of viscosifiers include polymers, e.g., guar, cellulose, xanthan, proteins, polypeptides or derivatives of the same or synthetic polymers, such as polyacrylamide-co-acrylic acid (PAM-AA), polyethylene oxide, polyacrylic acid, and other copolymers of acrylamide and other vinyl monomers. Other viscosifiers are also possible and will be known to those skilled in the art.

Oxygen Scavenger

In some embodiments, the composition comprises an oxygen scavenger. The oxygen scavenger may decrease the level of oxygen in the composition. Non-limiting examples of oxygen scavengers include sulfites and bisulfites. Other oxygen scavengers are also possible and will be known to those skilled in the art.

Clay Control Additive

In some embodiments, the composition comprises a clay control additive. The clay control additive may minimize damaging effects of clay (e.g., swelling, migration), e.g., during treatment of oil and/or gas wells. Non-limiting examples of clay control additives include quaternary ammonium chloride, tetramethylammonium chloride, polymers (e.g., polyanionic cellulose (PAC), partially hydrolyzed polyacrylamide (PHPA), etc.), glycols, sulfonated asphalt, lignite, sodium silicate, and choline chloride. Other clay control additives are also possible and will be known to those skilled in the art.

Paraffin Control Additive and/or Asphaltene Control Additive

In some embodiments, the composition comprises a paraffin control additive and/or an asphaltene control additive. The paraffin control additive or the asphaltene control additive may minimize paraffin deposition or asphaltene precipitation respectively in crude oil, e.g., during treatment of oil and/or gas wells. Non-limiting examples of paraffin control additives and asphaltene control additives include active acidic copolymers, active alkylated polyester, active alkylated polyester amides, active alkylated polyester imides, aromatic naphthas, and active amine sulfonates. Other paraffin control additives and asphaltene control additives are also possible and will be known to those skilled in the art.

Acid and/or Acid Precursor

In some embodiments, the composition comprises an acid or an acid precursor (e.g., an ester). For example, the composition may comprise an acid when used during acidizing operations. In some embodiments, the surfactant is alkaline and an acid (e.g., hydrochloric acid) may be used to adjust the pH of the composition towards neutral. Non-limiting examples of acids or di-acids include hydrochloric acid, acetic acid, formic acid, succinic acid, maleic acid, malic acid, lactic acid, and hydrochloric-hydrofluoric acids. In some embodiments, the composition comprises an organic acid or organic di-acid in the ester (or di-ester) form, whereby the ester (or diester) is hydrolyzed in the wellbore and/or reservoir to form the parent organic acid and an alcohol in the wellbore and/or reservoir. Non-limiting examples of esters or di-esters include isomers of methyl formate, ethyl formate, ethylene glycol diformate, alpha,alpha-4-trimethyl-3-cyclohexene-1-methylformate, methyl lactate, ethyl lactate, alpha,alpha-4-trimethyl 3-cyclohexene-1-methyllactate, ethylene glycol dilactate, ethylene glycol diacetate, methyl acetate, ethyl acetate, alpha,alpha,-4-trimethyl-3-cyclohexene-1-methylacetate, dimethyl succinate, dimethyl maleate, di(alpha,alpha-4-trimethyl-3-cyclohexene-1-methyl)-succinate, 1-methyl-4-(1-methylethenyl)-cyclohexylformate, 1-methyl-4-(1-ethylethenyl)-cyclohexylactate, 1-methyl-4-(1-methylethenyl)-cyclohexylacetate, and di(l-methy-4-(1-methylethenyl)cyclohexyl)-succinate. Other acids are also possible and will be known to those skilled in the art.

Salt

In some embodiments, the composition comprises a salt. The salt may reduce the amount of water needed as a carrier fluid and/or may lower the freezing point of the composition. Non limiting examples of salts include salts comprising K, Na, Br, Cr, Cs, or Li, e.g., halides of these metals, including but not limited to NaCl, KCl, CaCl₂, and MgCl₂. Other salts are also possible and will be known to those skilled in the art.

In some embodiments, the composition comprises an additive as described in U.S. patent application Ser. No. 15/457,792, filed Mar. 13, 2017, entitled “METHODS AND COMPOSITIONS INCORPORATING ALKYL POLYGLYCOSIDE SURFACTANT FOR USE IN OIL AND/OR GAS WELLS,” now published as US2017/0275518 on Sep. 28, 2017, herein incorporated by reference.

The compositions described herein may be formed using methods known to those of ordinary skill in the art. In some embodiments, the aqueous and non-aqueous phases may be combined (e.g., the water and the solvent(s)), followed by addition of surfactant(s) and optionally a co-solvent(s) (e.g., alcohol(s)) and agitation. The strength, type, and length of the agitation may be varied as known in the art depending on various factors including the components of the composition, the quantity of the composition, and the resulting type of composition (e.g., emulsion or microemulsion) formed. For example, for small samples, a few seconds of gentle mixing can yield an emulsion or microemulsion, whereas for larger samples, longer agitation times and/or stronger agitation may be required. Agitation may be provided by any suitable source, e.g., a vortex mixer, a stirrer (e.g., magnetic stirrer), etc.

Any suitable method for injecting the composition (e.g., a diluted emulsion or microemulsion) into a wellbore may be employed. For example, in some embodiments, the composition, optionally diluted, may be injected into a subterranean formation by injecting it into a well or wellbore in the zone of interest of the formation and thereafter pressurizing it into the formation for the selected distance. Methods for achieving the placement of a selected quantity of a mixture in a subterranean formation are known in the art. The well may be treated with the composition for a suitable period of time. The composition and/or other fluids may be removed from the well using known techniques, including producing the well.

It should be understood, that in embodiments where a composition is said to be injected into a wellbore, that the composition may be diluted and/or combined with other liquid component(s) prior to and/or during injection (e.g., via straight tubing, via coiled tubing, etc.). For example, in some embodiments, the composition is diluted with an aqueous carrier fluid (e.g., water, brine, sea water, fresh water, or a well-treatment fluid (e.g., an acid, a fracturing fluid comprising polymers, produced water, sand, slickwater, etc.,)) prior to and/or during injection into the wellbore. In some embodiments, a composition for injecting into a wellbore is provided comprising a composition as described herein and an aqueous carrier fluid, wherein the composition is present in an amount from about 0.1 gallons per thousand gallons (gpt) per dilution fluid to about 50 gpt, or from about 0.1 gpt to about 100 gpt, or from about 0.5 gpt to about 10 gpt, or from about 0.5 gpt to about 2 gpt.

The compositions described herein may be used in various aspects (e.g. steps) of the life cycle of an oil and/or gas well, including, but not limited to, drilling, mud displacement, casing, cementing, perforating, stimulation, kill fluids, enhanced oil recovery, improved oil recovery, stored fluid, and offshore applications. Inclusion of a composition into the fluids typically employed in these processes, e.g., drilling fluids, mud displacement fluids, casing fluids, cementing fluids, perforating fluid, stimulation fluids, kill fluids, etc., may result in many advantages as compared to use of the fluid alone.

Various aspects of the well life cycle are described in detail in U.S. patent application Ser. No. 14/212,731, filed Mar. 14, 2014, entitled “METHODS AND COMPOSITIONS FOR USE IN OIL AND/OR GAS WELLS,” now published as US/2014/0284053 on Sep. 25, 2014, and in U.S. patent application Ser. No. 14/212,763, filed Mar. 14, 2014, entitled “METHODS AND COMPOSITIONS FOR USE IN OIL AND/OR GAS WELLS,” now published as US/2014/0338911 on Nov. 20, 2014, and granted as U.S. Pat. No. 9,884,988 each herein incorporated by reference.

As will be understood by those of ordinary skill in the art, the steps of the life cycle of an oil and/or gas well may be carried out in a variety of orders. In addition, in some embodiments, each step may occur more than once in the life cycle of the well.

In some embodiments, the compositions described herein are used in methods to treat an oil and/or gas well having a wellbore, wherein the methods may comprise enhancing flowback and oil and/or gas production from the wellbore. In some embodiments, the composition (e.g., emulsion or microemulsion) may be diluted prior to use (e.g., diluted using 2% KCl by weight of water). In some embodiments, the dilution of the composition (e.g., emulsion or microemulsion) is to 2 gallons per thousand gallons. A method for enhancing flowback may comprise injecting the diluted composition into a subterranean formation, flowing back the well to recover aqueous fluid, and thereby producing the oil and/or gas from the well. Enhancing oil and/or gas production from the wellbore may comprise e.g. increasing solvation and dispersion of deposits comprising e.g., asphaltenes and/or paraffins by at least 5%, at least 10%, at least 20%, at least 30%, or at least 40% as compared with other well-treatment fluids.

In some embodiments, the compositions described herein are used in methods to treat an oil and/or gas well having a wellbore, wherein the methods may comprise reducing residues (e.g., wash-off of residues) on or near a wellbore. In some embodiments, the residues comprise kerogens, asphaltenes, paraffins, organic scale, or combinations thereof on or near the wellbore. In some embodiments, the composition may be diluted prior to use (e.g., diluted using 2% KCl by weight of water). In some cases, the dilution of the composition is to 2 gallons per thousand gallons.

In some embodiments, the compositions described herein are used in oil and/or gas wells that have a total dissolved solids from about 2,000 mg/L to about 400,000 mg/L. In some embodiments, the compositions described herein are used in oil and/or gas wells that have a total dissolved solids from about 90,000 mg/L to about 350,000 mg/L.

As used herein, the term emulsion is given its ordinary meaning in the art and refers to dispersions of one immiscible liquid in another, in the form of droplets, with diameters approximately in the range of 100-1,000 nanometers. Emulsions may be thermodynamically unstable and/or require high shear forces to induce their formation.

As used herein, the term microemulsion is given its ordinary meaning in the art and refers to dispersions of one immiscible liquid in another, in the form of droplets, with diameters approximately in the range of about from about 1 nanometers (nm) to about 1500 nm, about 1 nanometers (nm) to about 1000 nm, or from about 10 nm to about 1000 nm, or from about 10 nm to about 500 nm, or from about 10 nm to about 300 nm, or from about 10 nm to about 100 nm.

In some embodiments, prior to application, the microemulsion is diluted to form a nanodroplet dispersion. In some embodiments, application of the nanodroplet dispersion allows for the delivery of very small droplets of non-aqueous phase plus surfactant to the well having a wellbore and to subterranean formation. In some embodiments, the microemulsion may be diluted (e.g., with a second aqueous phase) to form an oil-in-water nanodroplet dispersion, prior to application to the well in a subterranean formation. In some embodiments the nanodroplet dispersion may comprise nanodroplets less than 50 nm. In some embodiments, the nanodroplet dispersion may comprise nanodroplets less than 100 nm. In some embodiments the nanodroplet dispersion may comprise nanodroplets less than 500 nm. In some embodiments the nanodroplet dispersion may comprise nanodroplets less than 1000 nm. In some embodiments the nanodroplet dispersion may comprise nanodroplets less than 1500 nm. In some embodiments, droplet size distribution may be a multi-modal distribution, i.e nanodroplet dispersion may be a polydisperse nanodroplet dispersion. Those skilled in the art will know appropriate means to measure particle size and particle size distribution, as for example, by using a dynamic light scattering instrument. In some embodiments, the second aqueous phase used to dilute microemulsion is formation produced water or a brine having from about 1000 to about 350,000 parts per million of total dissolved solids (“TDS”).

The microemulsion described herein may be diluted using methods known in the art. In some embodiments, the microemulsion is added to a second aqueous phase. The microemulsion may be present in the second aqueous phase in any suitable amount, for example, between about 0.01 wt % to about 5 wt %, or between about 0.01 wt % and about 2 wt %. In some embodiments, dilution of the microemulsion forms a nanodroplet dispersion, or swollen surfactant micelles. The aqueous phase may include any other suitable components (e.g. pH adjusting substances, buffers, salts, and other commonly used tank mix components).

Diluted microemulsions may exhibit turbidity. As used herein, “turbidity” refers to the measure of cloudiness or haziness of a fluid caused by the presence of suspended particles in the fluid. In the case of a fluid comprising a microemulsion or a microemulsion diluted into a tank-mix, turbidity serves as an indication of the stability of the microemulsion. A higher turbidity may be caused by phase separation of a less stable microemulsion upon dilution into high salinity and/or high temperature well conditions. Conversely, a low turbidity may be an indication that the microemulsion is more stable. Phase separation may decrease the efficacy of the microemulsion. Commonly-used units for measuring turbidity are Nephelometric Turbidity Units (NTU). A clear fluid corresponds to the fluid having a turbidity from 0 NTU to 15 NTU. A slightly hazy fluid corresponds to the fluid having a turbidity from 15 NTU to 100 NTU. A hazy fluid corresponds to the fluid having a turbidity from 100 NTU to 200 NTU. An opaque fluid corresponds to the fluid having a turbidity of 200 NTU or greater. In some embodiments a fluid having a turbidity of 200 NTU or greater may comprise nanodroplets of a variety of sizes ranging from about 5 nm to about 2000 nm. In some embodiments, the volume fraction of droplets larger than 1000 nm is less than about 50% of all of the droplets. In some embodiments, the volume fraction of droplets larger than 1000 nm is less than about 30% of all of the droplets. In some embodiments, the volume fraction of droplets larger than 1000 nm is less than about 20% of all of the droplets. In some embodiments, the volume fraction of droplets larger than 1000 nm is less than about 10% of all of the droplets. In some embodiments, the volume fraction of droplets larger than 1000 nm is less than about 1% of all of the droplets.

Microemulsions comprising greater than about 40% non-aqueous are challenging to formulate so as to obtain a nanodroplet dispersion upon dilution.

In some embodiments, microemulsions are clear or transparent because they contain particles smaller than the wavelength of visible light. In addition, microemulsions are homogeneous thermodynamically stable single phases, and form spontaneously, and thus, differ markedly from thermodynamically unstable emulsions, which generally depend on intense mixing energy for their formation. Microemulsions may be characterized by a variety of advantageous properties including, by not limited to, (i) clarity, (ii) very small particle size, (iii) ultra-low interfacial tensions, (iv) the ability to combine properties of water and oil in a single homogeneous fluid, (v) shelf life stability, and (vi) ease of preparation.

In some embodiments, the microemulsions described herein are stabilized microemulsions that are formed by the combination of a solvent-surfactant blend with an appropriate oil-based or water-based carrier fluid. Generally, the microemulsion forms upon simple mixing of the components without the need for high shearing generally required in the formation of ordinary emulsions. In some embodiments, the microemulsion is a thermodynamically stable system, and the droplets remain finely dispersed over time. In some embodiments, the average droplet size ranges from about 10 nm to about 300 nm.

It should be understood that the description herein which focuses on microemulsions is by no means limiting, and emulsions may be employed where appropriate.

In some embodiments, the emulsion or microemulsion is a single emulsion or a single microemulsion. For example, the emulsion or microemulsion comprises a single layer of a surfactant. In other embodiments, the emulsion or microemulsion may be a double or multilamellar emulsion or microemulsion. For example, the emulsion or microemulsion comprises two or more layers of a surfactant. In some embodiments, the emulsion or microemulsion comprises a single layer of surfactant surrounding a core (e.g., one or more of water, oil, solvent, and/or other additives) or a multiple layers of surfactant (e.g., two or more concentric layers surrounding the core). In certain embodiments, the emulsion or microemulsion comprises two or more immiscible cores (e.g., one or more of water, oil, solvent, and/or other additives which have equal or about equal affinities for the surfactant).

For convenience, certain terms employed in the specification, examples, and appended claims are listed here.

The term “emulsion” is given its ordinary meaning in the art and generally refers to a thermodynamically stable dispersion of water-in-oil or oil-in-water wherein in some embodiments (e.g., in the case of a macroemulsion) the interior phase is in the form of visually discernable droplets and the overall emulsion is cloudy, and wherein the droplet diameter may in some embodiments (e.g., in the case of a macroemulsion) be greater than about 300 nm.

The term “microemulsion” is given its ordinary meaning in the art and generally refers to a thermodynamically stable dispersion of water and oil that forms spontaneously upon mixture of oil, water and various surfactants. Microemulsion droplets generally have a mean diameter of less than 300 nm. Because microemulsion droplets are smaller than the wavelength of visible light, solutions comprising them are generally translucent or transparent, unless there are other components present that interfere with passage of visible light. In some embodiments, a microemulsion is substantially homogeneous. In other embodiments, microemulsion particles may co-exist with other surfactant-mediated systems, e.g., micelles, hydrosols, and/or macroemulsions. In some embodiments, the microemulsions of the present invention are oil-in-water microemulsions. In some embodiments, the majority of the oil component, e.g., (in various embodiments, greater than about 50%, greater than about 75%, or greater than about 90%), is located in microemulsion droplets rather than in micelles or macroemulsion droplets. In various embodiments, the microemulsions of the invention are clear or substantially clear.

The conventional terms water-in-oil and oil-in-water, whether referring to macroemulsions, emulsions, or microemulsions, simply describe systems that are water-discontinuous and water-continuous, respectively. They do not denote any additional restrictions on the range of substances denoted as “oil”.

The terms “clear” or “transparent” as applied to a microemulsion are given its ordinary meaning in the art and generally refers to the microemulsion appearing as a single phase without any particulate or colloidal material or a second phase being present when viewed by the naked eye. The colloidal nature of microemulsions can be verified by specialized experimental techniques, such as light scattering, x-ray scattering or acoustic spectroscopy.

The terms “substantially insoluble” or “insoluble” is given its ordinary meaning in the art and generally refers to embodiments wherein the solubility of the compound in a liquid is zero or negligible. In connection with the compositions described herein, the solubility of the compound may be insufficient to make the compound practicably usable in an agricultural end use without some modification either to increase its solubility or dispersability in the liquid (e.g., water), so as to increase the compound's bioavailability or avoid the use of excessively large volumes of solvent.

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999, the entire contents of which are incorporated herein by reference.

Certain compounds of the present invention may exist in particular geometric or stereoisomeric forms. The present invention contemplates all such compounds, including cis- and trans-isomers, R- and S-enantiomers, diastereomers, (D)-isomers, (L)-isomers, the racemic mixtures thereof, and other mixtures thereof, as falling within the scope of the invention. Additional asymmetric carbon atoms may be present in a substituent such as an alkyl group. All such isomers, as well as mixtures thereof, are intended to be included in this invention.

Isomeric mixtures containing any of a variety of isomer ratios may be utilized in accordance with the present invention. For example, where only two isomers are combined, mixtures containing 50:50, 60:40, 70:30, 80:20, 90:10, 95:5, 96:4, 97:3, 98:2, 99:1, or 100:0 isomer ratios are all contemplated by the present invention. Those of ordinary skill in the art will readily appreciate that analogous ratios are contemplated for more complex isomer mixtures.

The term “aliphatic,” as used herein, includes both saturated and unsaturated, nonaromatic, straight chain (i.e., unbranched), branched, acyclic, and cyclic (i.e., carbocyclic) hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. Thus, as used herein, the term “alkyl” includes straight, branched and cyclic alkyl groups. An analogous convention applies to other generic terms such as “alkenyl”, “alkynyl”, and the like. Furthermore, as used herein, the terms “alkyl”, “alkenyl”, “alkynyl”, and the like encompass both substituted and unsubstituted groups. In certain embodiments, as used herein, “aliphatic” is used to indicate those aliphatic groups (cyclic, acyclic, substituted, unsubstituted, branched or unbranched) having 1 to 20 carbon atoms. Aliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

As used herein, the term “alkyl” is given its ordinary meaning in the art and refers to the radical of saturated aliphatic groups, including straight chain alkyl groups, branched-chain alkyl groups, cycloalkyl (alicyclic) groups, alkyl substituted cycloalkyl groups, and cycloalkyl substituted alkyl groups. In some embodiments, the alkyl group may be a lower alkyl group, e.g., an alkyl group having 1 to 10 carbon atoms (e.g., methyl, ethyl, propyl, butyl, pentyl, hexyl, heptyl, octyl, nonyl, or decyl). In some embodiments, a straight chain or branched chain alkyl may have 30 or fewer carbon atoms in its backbone, and, in some embodiments, 20 or fewer. In some embodiments, a straight chain or branched chain alkyl may have 12 or fewer carbon atoms in its backbone (e.g., C₁-C₁₂ for straight chain, C₃-C₁₂ for branched chain), 6 or fewer, or 4 or fewer. Likewise, cycloalkyls may have from 3 to 10 carbon atoms in their ring structure, or 5, 6 or 7 carbon atoms in their ring structure. Examples of alkyl groups include, but are not limited to, methyl, ethyl, propyl, isopropyl, cyclopropyl, butyl, isobutyl, t-butyl, cyclobutyl, hexyl, and cyclochexyl.

The term “heteroalkyl” is given its ordinary meaning in the art and refers to an alkyl group as described herein in which one or more carbon atoms is replaced by a heteroatom. Suitable heteroatoms include oxygen, sulfur, nitrogen, phosphorus, and the like. Examples of heteroalkyl groups include, but are not limited to, alkoxy, alkoxyalkyl, amino, thioester, poly(ethylene glycol), and alkyl-substituted amino.

The terms “alkenyl” and “alkynyl” are given their ordinary meaning in the art and refer to unsaturated aliphatic groups analogous in length and possible substitution to the alkyls described above, but that contain at least one double or triple bond respectively.

In certain embodiments, the alkyl, alkenyl and alkynyl groups employed in the invention contain 1 to 20 aliphatic carbon atoms. In certain other embodiments, the alkyl, alkenyl, and alkynyl groups employed in the invention contain 1 to 10 aliphatic carbon atoms. In yet other embodiments, the alkyl, alkenyl, and alkynyl groups employed in the invention contain 1 to 8 aliphatic carbon atoms. In still other embodiments, the alkyl, alkenyl, and alkynyl groups employed in the invention contain 1 to 6 aliphatic carbon atoms. In yet other embodiments, the alkyl, alkenyl, and alkynyl groups employed in the invention contain 1 to 4 carbon atoms. Illustrative aliphatic groups thus include, but are not limited to, for example, methyl, ethyl, n-propyl, isopropyl, allyl, n-butyl, sec-butyl, isobutyl, t-butyl, n-pentyl, sec-pentyl, isopentyl, t-pentyl, n-hexyl, sec-hexyl, moieties and the like, which again, may bear one or more substituents. Alkenyl groups include, but are not limited to, for example, ethenyl, propenyl, butenyl, 1-methyl-2-buten-1-yl, and the like. Representative alkynyl groups include, but are not limited to, ethynyl, 2-propynyl (propargyl), 1-propynyl and the like.

The term “cycloalkyl,” as used herein, refers specifically to groups having three to ten, preferably three to seven carbon atoms. Suitable cycloalkyls include, but are not limited to cyclopropyl, cyclobutyl, cyclopentyl, cyclohexyl, cycloheptyl and the like, which, as in the case of other aliphatic, heteroaliphatic, or hetercyclic moieties, may optionally be substituted with substituents including, but not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)R^{x}; —CO₂(R^{x}); —CON(R^{x})₂; —OC(O)R^{x}; —OCO₂R; —OCON(R^{x})₂; —N(R^{x})₂; —S(O)₂R; —NR^{x}(CO)R^{x}, wherein each occurrence of R^{x} independently includes, but is not limited to, aliphatic, heteroaliphatic, aryl, heteroaryl, arylalkyl, or heteroarylalkyl, wherein any of the aliphatic, heteroaliphatic, arylalkyl, or to heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

The term “heteroaliphatic,” as used herein, refers to an aliphatic moiety, as defined herein, which includes both saturated and unsaturated, nonaromatic, straight chain (i.e., unbranched), branched, acyclic, cyclic (i.e., heterocyclic), or polycyclic hydrocarbons, which are optionally substituted with one or more functional groups, and that contain one or more oxygen, sulfur, nitrogen, phosphorus, or silicon atoms, e.g., in place of carbon atoms. In certain embodiments, heteroaliphatic moieties are substituted by independent replacement of one or more of the hydrogen atoms thereon with one or more substituents. As will be appreciated by one of ordinary skill in the art, “heteroaliphatic” is intended herein to include, but is not limited to, heteroalkyl, heteroalkenyl, heteroalkynyl, heterocycloalkyl, heterocycloalkenyl, and heterocycloalkynyl moieties. Thus, the term “heteroaliphatic” includes the terms “heteroalkyl,” “heteroalkenyl”, “heteroalkynyl”, and the like. Furthermore, as used herein, the terms “heteroalkyl”, “heteroalkenyl”, “heteroalkynyl”, and the like encompass both substituted and unsubstituted groups. In certain embodiments, as used herein, “heteroaliphatic” is used to indicate those heteroaliphatic groups (cyclic, acyclic, substituted, unsubstituted, branched or unbranched) having 1 to 20 carbon atoms. Heteroaliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, sulfinyl, sulfonyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The terms “heteroalkenyl” and “heteroalkynyl” are given their ordinary meaning in the art and refer to unsaturated aliphatic groups analogous in length and possible substitution to the heteroalkyls described above, but that contain at least one double or triple bond respectively.

Some examples of substituents of the above-described aliphatic (and other) moieties of compounds of the invention include, but are not limited to aliphatic; heteroaliphatic; aryl; heteroaryl; alkylaryl; alkylheteroaryl; alkoxy; aryloxy; heteroalkoxy; heteroaryloxy; alkylthio; arylthio; heteroalkylthio; heteroarylthio; F; Cl; Br; I; —OH; —NO₂; —CN; —CF₃; —CHF₂; —CH₂F; —CH₂CF₃; —CHCl₂; —CH₂OH; —CH₂CH₂OH; —CH₂NH₂; —CH₂SO₂CH₃; —C(O)R^{x}; —CO₂(R^{x}); —CON(R^{x})₂; —OC(O)R^{x}; —OCO₂R^{x}; —OCON(R^{x})₂; —N(R^{x})₂; —S(O)₂R^{x}; —NR^{x}(CO)R^{x} wherein each occurrence of R^{x} independently includes, but is not limited to, aliphatic, alycyclic, heteroaliphatic, heterocyclic, aryl, heteroaryl, alkylaryl, or alkylheteroaryl, wherein any of the aliphatic, heteroaliphatic, alkylaryl, or alkylheteroaryl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the examples that are described herein.

As used herein, the term “aromatic” is given its ordinary meaning in the art and refers to aromatic carbocyclic groups, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated pi electron system, while other, adjoining rings can be cycloalkyls, cycloalkenyls, cycloalkynyls, aryls and/or heterocyclyls.

As used herein, the term “aryl” is given its ordinary meaning in the art and refers to aromatic carbocyclic groups, optionally substituted, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated pi electron system, while other, adjoining rings can be cycloalkyls, cycloalkenyls, cycloalkynyls, aryls and/or heterocyclyls. The aryl group may be optionally substituted, as described herein. Substituents include, but are not limited to, any of the previously mentioned substituents, e.g., the substituents recited for aliphatic moieties, or for other moieties as disclosed herein, resulting in the formation of a stable compound. In some cases, an aryl group is a stable monocyclic or polycyclic unsaturated moiety having preferably 3 to 14 carbon atoms, each of which may be substituted or unsubstituted.

The term “heterocycle” is given its ordinary meaning in the art and refers to cyclic groups containing at least one heteroatom as a ring atom, in some embodiments, 1 to 3 heteroatoms as ring atoms, with the remainder of the ring atoms being carbon atoms. Suitable heteroatoms include oxygen, sulfur, nitrogen, phosphorus, and the like. In some embodiments, the heterocycle may be 3-membered to 10-membered ring structures or 3-membered to 7-membered rings, whose ring structures include one to four heteroatoms.

The term “heterocycle” may include heteroaryl groups, saturated heterocycles (e.g., cycloheteroalkyl) groups, or combinations thereof. The heterocycle may be a saturated molecule, or may comprise one or more double bonds. In some embodiments, the heterocycle is a nitrogen heterocycle, wherein at least one ring comprises at least one nitrogen ring atom. The heterocycles may be fused to other rings to form a polycylic heterocycle. The heterocycle may also be fused to a spirocyclic group. In some embodiments, the heterocycle may be attached to a compound via a nitrogen or a carbon atom in the ring.

Heterocycles include, e.g., thiophene, benzothiophene, thianthrene, furan, tetrahydrofuran, pyran, isobenzofuran, chromene, xanthene, phenoxathiin, pyrrole, dihydropyrrole, pyrrolidine, imidazole, pyrazole, pyrazine, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, triazole, tetrazole, oxazole, isoxazole, thiazole, isothiazole, phenanthridine, acridine, pyrimidine, phenanthroline, phenazine, phenarsazine, phenothiazine, furazan, phenoxazine, pyrrolidine, oxolane, thiolane, oxazole, oxazine, piperidine, homopiperidine (hexamnethyleneimine), piperazine (e.g., N-methyl piperazine), morpholine, lactones, lactams such as azetidinones and pyrrolidinones, sultams, sultones, other saturated and/or unsaturated derivatives thereof, and the like. The heterocyclic ring can be optionally substituted at one or more positions with such substituents as described herein. In some embodiments, the heterocycle may be bonded to a compound via a heteroatom ring atom (e.g., nitrogen). In some embodiments, the heterocycle may be bonded to a compound via a carbon ring atom. In some embodiments, the heterocycle is pyridine, imidazole, pyrazine, pyrimidine, pyridazine, acridine, acridin-9-amine, bipyridine, naphthyridine, quinoline, benzoquinoline, benzoisoquinoline, phenanthridine-1,9-diamine, or the like.

The term “heteroaryl” is given its ordinary meaning in the art and refers to aryl groups comprising at least one heteroatom as a ring atom. A “heteroaryl” is a stable heterocyclic or polyheterocyclic unsaturated moiety having preferably 3 to 14 carbon atoms, each of which may be substituted or unsubstituted. Substituents include, but are not limited to, any of the previously mentioned substituents, e.g., the substituents recited for aliphatic moieties, or for other moieties as disclosed herein, resulting in the formation of a stable compound. In some embodiments, a heteroaryl is a cyclic aromatic radical having from five to ten ring atoms of which one ring atom is selected from S, O, and N; zero, one, or two ring atoms are additional heteroatoms independently selected from S, O, and N; and the remaining ring atoms are carbon, the radical being joined to the rest of the molecule via any of the ring atoms, such as, e.g., pyridyl, pyrazinyl, pyrimidinyl, pyrrolyl, pyrazolyl, imidazolyl, thiazolyl, oxazolyl, isooxazolyl, thiadiazolyl,oxadiazolyl, thiophenyl, furanyl, quinolinyl, isoquinolinyl, and the like.

It will be appreciated that the above groups and/or compounds, as described herein, may be optionally substituted with any number of substituents or functional moieties. That is, any of the above groups may be optionally substituted. As used herein, the term “substituted” is contemplated to include all permissible substituents of organic compounds, “permissible” being in the context of the chemical rules of valence known to those of ordinary skill in the art. In general, the term “substituted” whether preceded by the term “optionally” or not, and substituents contained in formulas of this invention, refer to the replacement of hydrogen radicals in a given structure with the radical of a specified substituent. When more than one position in any given structure may be substituted with more than one substituent selected from a specified group, the substituent may be either the same or different at every position. It will be understood that “substituted” also includes that the substitution results in a stable compound, e.g., which does not spontaneously undergo transformation such as by rearrangement, cyclization, elimination, etc. In some embodiments, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl group” must still comprise the phenyl moiety and cannot be modified by substitution, in this definition, to become, e.g., a pyridine ring. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms.

Furthermore, this invention is not intended to be limited in any manner by the permissible substituents of organic compounds. Combinations of substituents and variables envisioned by this invention are preferably those that result in the formation of stable compounds useful for the formation of an imaging agent or an imaging agent precursor. The term “stable,” as used herein, preferably refers to compounds which possess stability sufficient to allow manufacture and which maintain the integrity of the compound for a sufficient period of time to be detected and preferably for a sufficient period of time to be useful for the purposes detailed herein.

Examples of optional substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, aryl, aryloxy, perhaloalkoxy, aralkoxy, heteroaryl, heteroaryloxy, heteroarylalkyl, heteroaralkoxy, azido, amino, halide, alkylthio, oxo, acylalkyl, carboxy esters, carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, cyano, alkoxyalkyl, perhaloalkyl, arylalkyloxyalkyl, and the like.

### EXAMPLES

These and other aspects of the present invention will be further appreciated upon consideration of the following Examples, which are intended to illustrate certain particular embodiments of the invention but are not intended to limit its scope. Table 1 shows the chemical composition of each Example. These compositions were prepared by mixing individual ingredients and then stirring the ingredients in a vortex mixer until microemulsion compositions were formed. The ingredients were mixed on a weight basis in the order they are listed in the specific examples, but this is one non-limiting way of mixing. Those skilled in the art would know alternative ways of mixing.

In the below examples, the ingredient identified as CNSL A is refined CNSL; CNSL B is unrefined CNSL; CNSL C is ethoxylated CNSL having a degree of ethoxylation of 1 mole of ethylene oxide per mole of CNSL; CNSL D is ethoxylated CNSL having a degree of ethoxylation of 13.5 moles of ethylene oxide per mole of CNSL; CNSL E is ethoxylated CNSL having a degree of ethoxylation of 6 moles of ethylene oxide per mole of CNSL; CNSL F is ethoxylated CNSL having a degree of ethoxylation of 20 moles of ethylene oxide per mole of CNSL.

Some of the examples are based on the use of non-aromatic compounds with a melting point above room temperature (i.e., from about 15° C.). In such examples, the non-aromatic compound identified as “TOD” (in the examples below) is a tall oil distillate byproduct of the pulp and paper industry, comprising saturated fatty acids. For example, Liqrene® D is an example of a TOD.

In some examples below, a difunctional block copolymer surfactant terminating in primary hydroxyl groups is used (i.e. Pluronic® L64).

TABLE 1
Composition of each Example.

| | |
|---|---|
| Component | wt % |

Example 1

| | |
|---|---|
| Linear, C₁₂-C₁₅, alcohol ethoxylate, 9 mol EO | 19 |
| Ethoxylated castor oil surfactant, 40 mol EO | 1 |
| Pluronic ® L64 surfactant | 7 |
| Dipropylene glycol monobutyl ether | 15.5 |
| Propylene glycol | 15.5 |
| 50% solution of CNSL A in d-limonene | 8.5 |
| 50 wt % solution of CNSL A in alpha-terpineol | 8.5 |
| Water | 25 |

Example 2

| | |
|---|---|
| Linear, C₁₂-C₁₅, alcohol ethoxylate, 9 mol EO | 19 |
| Ethoxylated castor oil surfactant, 40 mol EO | 1 |
| Pluronic ® L64 surfactant | 7 |
| Dipropylene glycol monobutyl ether | 15.5 |
| Propylene glycol | 15.5 |
| 50% solution of CNSL B solution in d-limonene | 8.5 |
| 50% solution of CNSL B solution in alpha- | 8.5 |
| terpineol | |
| Water | 25 |

Example 3

| Linear, C₁₂-C₁₅ alcohol ethoxylate, 9 mol EO | 19 |
|---|---|
| Ethoxylated castor oil surfactant, 40 mol EO | 1 |
| Pluronic ® L64 surfactant | 7 |
| Dipropylene glycol monobutyl ether | 15.5 |
| Propylene glycol | 15.5 |
| 50% solution of CNSL C in d-limonene | 8.5 |
| 50% solution of CNSL C in alpha-terpineol | 8.5 |
| Water | 25 |
| Example 4 | |
| This Example is a microemulsion composition that | |
| comprises an aromatic compound with a melting point | |
| greater than room temperature, specifically | |
| naphthalene. | |
| Linear, C₁₂-C₁₅ alcohol ethoxylate, 9 mol EO | 19 |
| Ethoxylated castor oil surfactant, 40 mol EO | 1 |
| Pluronic ® L64 surfactant | 7 |
| 15% solution of naphthalene in dipropelene | 15.5 |
| glycol monobutyl ether | |
| Propylene glycol | 15.5 |
| 8.8% solution of naphthalene in alpha-terpineol | 8.5 |
| Water | 25 |
| Example 5 | |
| This Example is a microemulsion composition that | |
| comprises an aromatic compound with a melting point | |
| greater than room temperature, specifically | |
| naphthalene. | |
| Linear C₁₂-C₁₅ alcohol ethoxylate, 7 mol EO | 23 |
| Isopropanol | 23 |
| 15% solution of naphthalene in d-limonene | 15 |
| Water | 39 |

Example 6

| | |
|---|---|
| Linear, C₁₂-C₁₅ alcohol ethoxylate, 7 mol EO | 23 |
| Isopropanol | 23 |
| 50% solution of CNSL A in d-limonene | 15 |
| Water | 39 |

Example 7

| | |
|---|---|
| Linear, C₁₂-C₁₅ alcohol ethoxylate, 7 mol EO | 23 |
| Isopropanol | 23 |
| 50% solution of CNSL B in d-limonene | 15 |
| Water | 39 |

Example 8

| | |
|---|---|
| Linear, C₁₂-C₁₅ alcohol ethoxylate , 7 mol EO | 25 |
| Propylene glycol | 15 |
| Isopropanol | 15 |
| CNSL A | 5 |
| Alkoxylated polyamines | 5 |
| Water | 25 |

Example 9

| | |
|---|---|
| CNSL D | 32.5 |
| Isopropanol | 32.5 |
| CNSL A | 5 |
| Water | 30 |

Example 10

| | |
|---|---|
| CNSL C | 5 |
| CNSL F | 70 |
| Water | 25 |

Example 11

| | |
|---|---|
| Linear C₁₂-C₁₅ alcohol ethoxylate, 7 mol EO | 23 |
| Isopropanol | 23 |
| d-limonene | 7.5 |
| CNSL A | 5 |
| Water | 30 |

Example 12

| | |
|---|---|
| CNSL D | 32.5 |
| CNSL A | 5 |
| Isopropanol | 32.5 |
| Water | 30 |

Example 13

| | |
|---|---|
| CNSL D | 12.6 |
| CNSL E | 3.4 |
| Isopropanol | 16 |
| d-limonene | 34 |
| Water | 34 |

Example 14

| | |
|---|---|
| CNSL D | 18 |
| CNSL E | 5 |
| Isopropanol | 22 |
| d-limonene | 15 |
| Water | 40 |

Example 15

| | |
|---|---|
| Linear C₁₂-C₁₅ alcohol ethoxylate, 7 mol EO | 23 |
| 30% solution TOD in Isopropanol | 23 |
| 13% solution TOD in d-limonene | 15 |
| Water | 39 |

Example 16

| | |
|---|---|
| Linear C₁₂-C₁₅ alcohol ethoxylate, 7 mol EO | 23 |
| 15% solution TOD solution in Isopropanol | 23 |
| 13% solution TOD solution in d-limonene | 15 |
| Water | 39 |

Example 17

| | |
|---|---|
| Linear C₁₂-C₁₅ alcohol ethoxylate, 7 mol EO | 23 |
| Isopropanol | 23 |
| 13% solution TOD solution in d-limonene | 15 |
| Water | 39 |

Example 18

| | |
|---|---|
| Linear C₁₂-C₁₅ alcohol ethoxylate, 7 mol EO | 23 |
| Isopropanol | 23 |
| 5% solution TOD in d-limonene | 15 |
| Water | 39 |

Example 19

| | |
|---|---|
| Linear C₁₂-C₁₅ alcohol ethoxylate, 9 mol EO | 25 |
| Ethylene glycol monobutyl ether | 25 |
| 13% solution TOD solution in d-limonene | 12.5 |
| 30% solution TOD solution in alpha-terpineol | 12.5 |
| Water | 25 |

Example 20

| Linear C₁₂-C₁₅ alcohol ethoxylate, 9 mol EO | 25 |
|---|---|
| Dipropylene glycol monobutyl ether | 12.5 |
| Triethylene glycol | 12.5 |
| 13% solution TOD in d-limonene | 12.5 |
| 30% solution TOD solution in alpha-terpineol | 12.5 |
| Water | 25 |
| Reference Microemulsion 1 | |
| The non-aqueous phase of Reference Microemulsion 1 | |
| did not contain CNSL, did not contain aromatic | |
| compounds with a melting point greater than room | |
| temperature, and did not contain non-aromatic | |
| compounds with a melting point greater than room | |
| temperature. | |
| Linear C₁₂-C₁₅ alcohol ethoxylate, 7 mol EO | 23 |
| Isopropanol | 23 |
| d-limonene | 15 |
| Water | 39 |
| Reference Microemulsion 2 | |
| The non-aqueous phase of Reference Microemulsion 2 | |
| did not contain CNSL, did not contain aromatic | |
| compounds with a melting point greater than room | |
| temperature, and did not contain non-aromatic | |
| compounds with a melting point greater than room | |
| temperature. | |
| Linear C₁₂-C₁₅ alcohol ethoxylate, 9 mol EO | 19 |
| Ethoxylated castor oil surfactant, 40 mol EO | 1 |
| Pluronic ® L64 surfactant | 7 |
| Dipropylene glycol monobutyl ether | 15.5 |
| Propylene glycol | 15.5 |
| d-limonene | 8.5 |
| Alpha-terpineol | 8.5 |
| Water | 25 |

### Performance Evaluation Experiments

### Experiment 1

In Experiment 1, the impact of a microemulsion composition comprising CNSL (Example 8) on the effectiveness of aqueous phase displacement by gravity using a centrifuge is demonstrated. A 25 g plastic cartridge had its top cap unscrewed and placed aside. A top plastic frit was then removed and set aside. A ruler and a marker were used to make eight markings, spaced in 10 mm increments, up the height of the cartridge starting from the bottom of the cartridge. The cartridge was secured to a rotary shaker. A known weight of 2% KCl solution was transferred to a plastic cup, and added to the cartridge to a height of 40 mm. The weight of the remaining 2% KCl brine solution was recorded, and the amount of 2% KCl brine solution inside the cartridge was calculated through mass by difference. A separate plastic container was filled with clean, 100 mesh Oklahoma sand, placed on a balance, and had its weight recorded. The sand was then added to the cartridge up to the 10 mm mark, at which point, the top cap was replaced. The rotary shaker was set to 950 RPM, and subsequently shook the cartridge for 1 minute as measured by a timer. After 1 minute, the top cap of the cartridge was removed. The process of adding sand to the cartridge continued in 10 mm increments and shaking the column for 1 minute continued, until the sand formed a column totaling 80 mm in height. The plastic container of residual 100 mesh Oklahoma sand was weighed, and recorded. The weight of sand in the cartridge was calculated through mass by difference. Residual 2% KCl brine solution was removed from the inside of the cartridge until the height of the sand was equal to the height of the 2% KCl brine solution. The weight of 2% KCl brine solution inside the cartridge was then calculated using mass by difference. The top plastic frit was placed atop the sand pack, and was pressed into the top of the sand pack using a torque wrench to apply 20 ft-lbs of force. The cartridge was weighed and its weight was recorded.

The composition of Example 8 was diluted to 2 gpt (gallons per thousand) in a 2% KCl brine solution to a total volume of 100 mL and added to a 60 mL plastic syringe attached to a syringe pump, such as that available from Harvard Corporation. The treated solution was pushed through the cartridge at 20 mL per minute by attaching plastic tubing to the outlet of the syringe and the inlet of the cartridge. Once the cartridge had been treated, excess treatment solution was removed from the top of the cartridge and weighed. The top cap was screwed back in place on the cartridge, and weighed once again to account for any mass differences as a result of treatment imbibing into the cartridge.

The cartridge was then placed into a pre-weighed, centrifuge tube container adapter, designed to accommodate the cartridge. The bottom screw cap of the cartridge was removed, and then the top screw cap was removed as well. The cartridge and the centrifuge tube container adapter were placed inside a centrifuge and set to run at 200 RPM for 5 minutes. After the 5 minutes of centrifuging, the cartridge was removed, and the centrifuge tube container adapter was weighed, which contained the aqueous solution that was forced out from the cartridge during the centrifuging process. The aqueous solution was displaced by gas during centrifugation. This procedure was repeated at 300, 400, 500, 600, 800, and 1000 RPMs, for 5 minutes each.

The difference in weight between the empty centrifuge tube container adapter and the centrifuge tube container adapter containing the aqueous solution, represented the weight of aqueous solution that was displaced as a function of a fixed amount of capillary pressure. When more aqueous solution is displaced at a lower RPM setting, it is indicative that a treatment was able to offload water from a silica surface with less pressure than other treatments or additives. Less pressure being required to displace a fixed amount of aqueous phase can be interpreted as a treatment requiring less force to be applied downhole by a pump at an oilfield to achieve the same recovery of traditional additives. The operation of industrial pumps during a flowback operation represent a significant cost, and lessening the force required to displace aqueous phase has the potential to save significant amounts of time and money. The results of this experiment are reported in residual water saturation (S_{w}) vs. RPM. Residual water saturation is an expression for the remaining aqueous solution inside the cartridge that had not yet been pushed out into the centrifuge tube container adapter.

TABLE 2
Performance of CNSL-based microemulsion in the
effectiveness of liquid displacement by gas from sand-based
porous media in a centrifuge-based liquid displacement test. In the
centrifuge test, the saturation of the sand pack with aqueous phase
was measured as a function of revolutions per minute (RPM) speed
in a centrifuge. Lower saturation at a given centrifuge speed
indicates higher performance.

| | Water Saturation, | |
|---|---|---|
| | S_{w} (%) | |
| | Composition of | Water Saturation, |
| Centrifuge Speed | Example 8 | S_{w} (%) |
| (RPM) | in 2 wt % KCl Brine | 2 wt % KCl Brine |
| 200 | 46.9 | 98.2 |
| 300 | 25.0 | 71.6 |
| 400 | 12.5 | 50.3 |
| 500 | 7.5 | 34.0 |
| 600 | 3.6 | 29.4 |
| 800 | 1.3 | 19.8 |
| 1000 | 0 | 18.4 |

Table 2 shows that the composition of Example 8 enhances liquid displacement by gas by at least a factor of two relative to 2 wt % KCl brine without any additive recovery. Experiment 2 shows that the microemulsion of Example 8 is anticipated to be effective at removing water blockages in a well to provide a path for hydrocarbons to flow out to the surface. Specifically, Table 2 shows that the use of the microemulsion of Example 8 produced lower water saturations at corresponding speeds of rotation as compared to brine alone. This indicates that less water has been trapped in the sand pack, which would result in more effective hydrocarbon flow through said sand pack. In the field, this result would correspond to a more effective hydrocarbon production from the well.

### Experiment 2

In Experiment 2, the effectiveness of selected microemulsion compositions comprising CNSL (i.e. Examples 1-3, 6, 7, 11, 12, and 14) were measured for the production of oil by performing a sequential aqueous phase displacement study from packed columns.

In addition, in Experiment 2, microemulsion compositions comprising an aromatic compound with a melting point greater than room temperature (i.e., Examples 4 and 5) and microemulsion compositions comprising a non-aromatic compound with a melting point greater than room temperature (i.e., Examples 18 and 19) were also tested.

First, 100 mesh Oklahoma sand was washed with deionized water and dried in the oven. The sand was then split on a sand splitter. A lower end piece with a nozzle equipped with a paper filter insert was mounted onto a 25 cm tall glass column having an inner diameter of 2.5 cm. A piece of hose with a hose clamp was attached to the nozzle.

Approximately 50 g of sand was placed in a 50 mL tripour beaker and the mass of sand was determined. The testing was conducted with the mixture of sand and cleaned drill cuttings from an oilfield well. The mixture consisted of 85% sand and 15% cuttings. To remove the oily contaminants present on cuttings from the drilling process, cleaning procedures were used to treat the cuttings with solvents such as xylene and isopropanol. Specific methods of cleaning drill cuttings will be known to a person skilled in the art. The cuttings were dried after being cleaned.

Next, a 400 mL tripour beaker was tared on a balance and approximately 100 mL of base fluid consisting of either formation produced water or a brine of composition mimicking the composition of produced water was placed into the beaker. The mass of base fluid was determined. The hose clamp was tightened to achieve a fully closed position and the base fluid from the beaker was then poured into a column up to the 5 cm mark. The mass of residual fluid remaining in the beaker was recorded, and the mass of fluid placed into the column was determined. A powder funnel was then placed at the top of the column. Pre-weighed sand or sand/cuttings mixture were poured in increments into the column, filling 1 cm of column height with each increment. After the addition of each sand portion, the liquid and sand in the column were vibrated with a percussion massager placed in contact for approximately 5 seconds with each side of the column. After the addition of sand or sand/cuttings mixture to base fluid was completed, the excess fluid above the sand pack in the column was gently removed by suction with a transfer pipette into a tared 20 mL syringe equipped with a syringe filter. The fluid was removed until the meniscus of the remaining fluid was barely contacting the sand pack. Mass of fluid removed from the column was measured, and the amount of fluid remaining in the column was determined from the mass difference. That amount corresponded to one pore volume of fluid in the packed bed.

Next, 45 g of treatment solutions composed of each of the microemulsion compositions of Examples 1-7, 11, 12, 14, 18, and 19 diluted to 2 gallons per thousand (gpt) with base brine were prepared. This amount corresponds to the 5 pore volumes of the treatment solution. In Experiment 2, a variety of base brines were used as set forth in Table 3. The entire amount of each of the treatment solutions was added to the top of the packed bed with a transfer pipette. The empty beaker was placed underneath the column and the clamp was opened to allow the flow. Once the entire amount of each of the treatment solution flowed through the pack and the fluid meniscus had just touched the top of the sand pack, the hose clamp was closed to stop the flow. This column is further referred to as Column #1. The fluid drained from Column #1 was used as a base fluid in place of brine to pack the second column (referred to as Column #2) in the same manner as described above. The excess fluid was removed from the space above the sand with a transfer pipette as described above. Crude oil was then added to the top of each of Column #1 and Column #2 to the 10 cm mark, respectively. The column height therefore contained 5 cm of aqueous phase and sand and 5 cm of crude oil. In Column #1 and Column #2, the level of crude oil was always maintained at the 10 cm mark throughout the experiment and the oil was replenished as necessary. At the beginning of displacement experiments, empty 50 mL tripour beakers were weighed and placed under the nozzle of each Column #1 and Column #2. The hose clamp was opened and the aqueous fluid started to be collected from each of Column #1 and Column #2. After selected time increments the tripour beakers placed under the nozzles of Columns #1 and 2 were replaced with empty tripour beakers and the amount of aqueous liquid recovered from each Column #1 and Column #2 over the specified time was determined. The masses of the portions of liquid recovered over different time increments were added together and the total recovery of aqueous fluid from Column #1 and Column #2 was determined. The greater the extent of recovery, the more effective is the anticipated displacement of aqueous phase by oil. Results of recovery experiments with the microemulsion compositions from Examples 1-7, 11, 12, 14, 18, and 19 are shown in Table 4 and the summary of oils, brines and column packing materials are shown in Table 3.

TABLE 3
Oils, brines, and column packing used in oil displacement experiments

| | Oil | Brine | Column packing |
|---|---|---|---|
| Oil 1/ | Midland Basin Oil | Midland Basin | 100 mesh sand |
| Brine 1 | API gravity 46.2° | Synthetic Brine | |
| | | TDS 122,136 | |
| Oil 2/ | Delaware Basin Oil | Delaware Basin | 85% sand |
| Brine 2 | API gravity 45.0° | Synthetic Brine | 15% formation |
| | | TDS 90,099 | cuttings |
| Oil 3/ | Williston Basin Oil | Williston Basin | 85% sand |
| Brine 3 | API gravity 36.2° | Produced water | 15% formation |
| | | TDS 350,229 | cuttings |
| Oil 4/ | Lower Wolfcamp Oil | Lower Wolfcamp | 85% sand |
| Brine 4 | API gravity 41.3° | Synthetic Brine | 15% formation |
| | | TDS 107,421 | cuttings |
| Oil 5/ | Eagle Ford Oil | 2% KCl brine | 85% sand |
| Brine 5 | API gravity 43.7° | TDS 2,000 | 15% Wolfcamp |
| | | | formation cuttings |

In Table 3, “TDS” means total dissolved solids, which is a measure of the dissolved combined content of mineral salts in water, in parts per million (ppm) or mg/L.

TABLE 4
Effectiveness of microemulsion compositions in production of oil.

| | | |
|---|---|---|
| | Column #1 | Column #2 |
| Example | Recovery | Recovery |

Oil 1/Brine 1

| | | |
|---|---|---|
| Brine only | 23% | 23% |
| 231-80-2 Example 18 | 76% | 43% |
| 231-80-3 Example 19 | 74% | 40% |

Oil 2/Brine 2

| | | |
|---|---|---|
| Brine only | 5.6% | 5.6% |
| 172-98-1 (Reference | 80% | 11% |
| Microemulsion 1) | | |
| 172-98-2 Example 11 | 71% | 13% |
| 172-98-5 Example 12 | 82% | 70% |
| 172-99-2 Example 14 | 82% | 7% |

Oil 3/Brine 3

| | | |
|---|---|---|
| Brine only | 5% | 5% |
| 172-98-1 (Reference | 64% | 6% |
| Microemulsion 1) | | |
| 172-98-2 Example 11 | 74% | 6% |
| 172-98-5 Example 12 | 77% | 8% |
| 172-99-2 Example 14 | 79% | 7% |

Oil 4/Brine 4

| | | |
|---|---|---|
| Brine only | 9% | 9% |
| 172-98-1 (Reference | 87% | 35% |
| Microemulsion 1) | | |
| 172-98-2 Example 11 | 88% | 9% |
| 172-98-5 Example 12 | 80% | 77% |
| 172-99-2 Example 14 | 83% | 8% |

Oil 5/Brine 5

| | | |
|---|---|---|
| Brine only | 2% | 2% |
| 231-86-1MF Reference | 82% | 2% |
| Microemulsion 1 | | |
| 231-86-2 Example 14 | 84% | 37% |
| 231-86-3 Example 5 | 78% | 17% |
| 231-87-1 Example 6 | 77% | 3% |
| 231-87-2 Example 7 | 89% | 2% |
| 231-88-0 Reference | 84% | 74% |
| Microemulsion 2 | | |
| 231-88-1 Example 4 | 81% | 67% |
| 231-89-1 Example 2 | 80% | 51% |
| 231-89-2 Example 1 | 79% | 52% |
| 231-89-3 Example 3 | 78% | 53% |

Data in Table 4 show that in the absence of any microemulsion, the oils were capable of displacing less than 25%, and more typically less than 10%, of the corresponding brines. The addition of the reference microemulsions to brine as well as of the inventive microemulsions resulted in a significant increase of aqueous phase displacement; typically over 60% and up to 90% could be displaced from Column #1. The effectiveness of aqueous fluid displacement from Column #2 was typically lower than from Column #1. Without wishing to be bound by theory, this decrease in effectiveness can be to a large extent attributed to the adsorption of the microemulsion components on the material of the column packing. The composition of oils and brines can also play a role in this decrease of aqueous phase production. The microemulsion treatment persistence may be assessed by comparing the effectiveness of aqueous phase displacement from Columns #1 and Column #2: the higher the effectiveness of displacement from Column #2, the greater depth the fluid treated with a given microemulsion is expected to penetrate in the formation. Results shown in Table 4 indicate that the microemulsion of Example 12 showed an unusually high persistence, significantly outperforming other compositions tested, including both of the reference microemulsion compositions. This result was surprising and unexpected.

As shown in Table 4, unexpectedly, the microemulsions of Examples 11, 12, and 14 comprising CNSL and/or ethoxylated CNSL had superior performance in very heavy brine exceeding 350,000 TDS salinity, outperforming Reference Microemulsion 1. Thus, the microemulsion compositions of Examples 11, 12, and 14 can be particularly suitable for treating wells containing water with very high salinity.

Overall, data in Table 4 shows that microemulsion treatments of Examples 1-7, 1, 12, 14, 18, and 19 are effective in promoting the displacement of various brines by different oils, as evidenced by high percent of water recovery from Column #1, and in some cases, are more effective than the Reference Microemulsion 1 and Reference Microcmulsion 2.

### Experiment 3

In Experiment 3, the effectiveness of microemulsion compositions comprising CNSL (i.e., Examples 1-3, 6, and 7), a microemulsion composition comprising an aromatic compound with a melting point greater than room temperature (i.e., Example 4), and a microemulsion composition comprising a non-aromatic compound with a melting point greater than room temperature (i.e., Example 15) at removing or cleaning asphaltenic deposits are demonstrated.

The experimental procedure involves the coating of 100 mesh sand with crude oil deposit from an asphaltenic crude oil. First, 200 g of water-washed 100-mesh Oklahoma sand were placed into a wide-mouth glass jar. Next, 30 mL of asphaltenic crude oil were added to the sand. An asphaltenic crude oil with American Petroleum Institute (API) gravity of less than 38° is generally suitable for sand treatment. Crude oil with API gravity of less than 25° is preferable. Sand and oil were mixed at 500 RPM using a mixer for 3 minutes. Oil-coated sand was evenly spread on an aluminum pan and was dried for 18 hours in the explosion-proof oven. After drying, the coated sand was weighed and washed with twice its weight of isopropanol. During washing, the coated sand was stirred with isopropanol at 500 RPM for 1 minute using the mixer. After washing, the sand was evenly spread on aluminum pan and the excess isopropanol was driven off by evaporation in an explosion proof oven for 2 hours.

In a typical test, 5 g of treated sand was placed into a 50 mL wide-mouth glass jar and 10 g of each of the treatment fluids composed of the microemulsion compositions of Examples 1-4, 6, 7, 15 and Reference Microemulsions 1 and 2 were each diluted to 2 gpt with 2% KCl brine and were added to sand in separate glass jars. Each of the glass jars was then vigorously shaken for 10 minutes using a shaking device. After shaking, 8 g of treatment fluid for each sand sample was transferred into individual clean tared centrifuge tubes. The extraction mixture containing 4.0 g of xylene and 0.7 g of ethylene glycol monobutyl ether (EGMBE) was added to each tube, and the tube final masses were recorded. It is anticipated that, depending on the crude oil used to prepare the coated sand, it may be beneficial to optimize the amount of EGMBE may in order to facilitate effective transfer of crude oil components from the interface into xylene. Each of the tubes were then placed into the centrifuge and spun at 3000 RPM for 10 minutes at an acceleration of 9 g. After centrifugation, the contents of each tube separated into two layers. The upper xylene layer was removed with a pipette and transferred into a 10 mL vial. The absorbance of prepared xylene extracts was then measured at 400 nm using a commercial UV/Vis spectrophotometer. The results of the experiments were interpreted in terms of grams of crude oil removed from sand per mL of added xylene, which was estimated from the measured absorbance utilizing a pre-determined calibration curve.

To establish a calibration curve, 5 g of crude oil-coated sand was placed into a 50 mL glass jar. Xylene was then added to the jar in 5 g increments, and the jar was swirled for 30 seconds. Dirty xylene was then transferred to a 50 mL jar without simultaneously transferring sand. The addition of xylene was repeated approximately 5-6 times until the sand was completely clean and the xylene layer was completely clear. The jar containing clean sand was dried by evaporating the xylene residue in a kinetic oven for over 2 hours. After cooling down, the mass of clean sand was determined and the mass of crude oil coating was calculated by the difference in mass of original and treated sand. The amount of removed crude oil per mL of added xylene could then be calculated. The volume of added xylene was determined by dividing the mass of xylene by the density of xylene (0.864 g/cm³). The density of xylene was shown not to change with the addition of dissolved oil. The concentrate of crude oil in xylene was then diluted with xylene to yield 1 wt. %, 2 wt. %, 3 wt. %, 4 wt. %, and 5 wt. % solutions. The absorbance of these diluted solutions was measured with a UV/V is spectrophotometer at 400 nm and a linear calibration curve was established.

The efficiencies of crude oil removal by the microemulsion compositions of Examples 1-4, 6, 7, and 15 are summarized in Table 5.

TABLE 5
Effectiveness of microemulsion compositions
in removal of crude oil.

| Microemulsion Treatment | % Crude Removed |
|---|---|
| 231-86-1MF Reference | 61 ± 9% |
| Microemulsion 1 | |
| 231-86-2 Example 15 | 62 ± 11% |
| 231-87-1 Example 6 | 69 ± 2% |
| 231-87-2 Example 7 | 44 ± 5% |
| 231-88-0 Reference | 14.2 ± 0.1% |
| Microemulsion 2 | |
| 231-88-1 Example 4 | 20 ± 1% |
| 231-89-1 Example 2 | 11 ± 1% |
| 231-89-2 Example 1 | 8.2 ± 0.4% |
| 231-89-3 Example 3 | 7.9 ± 0.4% |

The results in Table 5 indicate that microemulsion treatments of Examples 6, 7, and 15 were effective in removing 40% or more of deposited crude from the sand surface. Unexpectedly, the data show that the microemulsion composition of Example 6 was the most effective.

Table 5 shows that microemulsions containing alpha-terpineol solvent (e.g. Examples 1-4 and Reference Microemulsion 2) are not the best candidates for treating wells with asphaltenic deposits as evidenced by their ability to remove less than 25% of deposited crude oil. However, all of these microemulsions showed some effectiveness in removing deposited crude oil. In particular, the microemulsion of Example 4, comprising an aromatic compound with a melting point above room temperature, showed an unexpectedly high effectiveness for removing crude oil deposits in comparison to other alpha-terpineol-based compositions, including Reference Microemulsion 2. This result indicates that naphthalene was effective in increasing the crude oil removing performance of alpha-terpineol based compositions.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, e.g. elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, e.g. the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element or a list of elements. In general, the term “or” as used herein shall only be interpreted as indicating exclusive alternatives (e.g. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “between” in reference to a range of elements or a range of units should be understood to include the lower and upper range of the elements or the lower and upper range of the units, respectively. For example, the phrase describing a molecule having “between 6 to 12 carbon atoms” should mean a molecule that may have, e.g., from 6 carbon atoms to 12 carbon atoms, inclusively. For example, the phrase describing a composition comprising “between about 5 wt % and about 40 wt % surfactant” should mean the composition may have, e.g., from about 5 wt % to about 40 wt % surfactant, inclusively.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, e.g. to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A microemulsion for treating an oil and/or gas well having a wellbore, comprising:
an aqueous phase;
a surfactant; and
a non-aqueous phase comprising cashew nut shell liquid.

2. The microemulsion of claim 1, wherein the non-aqueous phase further comprises a terpene.

3. The microemulsion of claim 1, wherein the surfactant comprises a derivatized cashew nut shell liquid, a linear alcohol ethoxylate, or a combination thereof.

4. The microemulsion of claim 3, wherein the derivatized cashew nut shell liquid is an ethoxylated cashew nut shell liquid.

5. The microemulsion of claim 1, wherein the non-aqueous phase further comprises a co-solvent.

6. The microemulsion of claim 1, wherein the microemulsion further comprises a derivatized cashew nut shell liquid.

7. A microemulsion for treating an oil and/or gas well having a wellbore, comprising:
an aqueous phase;
a surfactant; and
a non-aqueous phase comprising derivatized cashew nut shell liquid.

8. The microemulsion composition of claim 7, wherein the derivatized cashew nut shell liquid is an ethoxylated cashew nut shell liquid.

9. The microemulsion composition of 7, therein the surfactant is a derivatized cashew nut shell liquid.

10. The microemulsion composition of 9, wherein the derivatized cashew nut shell liquid is an ethoxylated cashew nut shell liquid.

11. A microemulsion for treating an oil and/or gas well having a wellbore, comprising:
an aqueous phase;
a surfactant; and
a non-aqueous phase comprising at least one terpene and at least one additive, wherein the additive is an aromatic compound having a melting point above 15° C. selected from the group consisting of derivatized and underivatized naphthalene, anthracene, phenanthrene, pyrene, fluoranthene, benzopyrene, chrysene, perylene, phenol, catechol, aminophenol, coniferyl alcohol and esters thereof, synapyl alcohol, syringol, syringaldehyde, syringic acid, acetosyringone, sinapine, canolol, cannabinol, cannabidiol, phenolic resins, lignin, derivatized lignin, derivatized cashew nut shell liquid, ethoxylated cashew nut shell liquid, and combinations thereof.

12. The microemulsion of claim 11, wherein the non-aqueous phase further comprises cashew nut shell liquid.

13. The microemulsion of claim 11, wherein the surfactant comprises a derivatized cashew nut shell liquid, a linear alcohol ethoxylate, or a combination thereof.

14. The microemulsion of claim 13, wherein the derivatized cashew nut shell liquid is an ethoxylated cashew nut shell liquid.

15. The microemulsion of claim 11, wherein the non-aqueous phase further comprises a co-solvent.

16. A method of treating an oil and/or gas well having a wellbore, comprising:
delivering a composition into the wellbore, wherein the composition comprises
a microemulsion, wherein the microemulsion comprises:
an aqueous phase;
a surfactant; and
a non-aqueous phase comprising cashew nut shell liquid;
and wherein the composition enhances flowback and oil and/or gas production from the wellbore.

17. The method of claim 16, wherein the well has a total dissolved solids from about 90,000 mg/L to about 350,000 mg/L.

18. The method of claim 16, wherein the non-aqueous phase further comprises a terpene.

19. The method of claim 16, wherein the surfactant comprises a derivatized cashew nut shell liquid, a linear alcohol ethoxylate, or a combination thereof.

20. The method of claim 19, wherein the derivatized cashew nut shell liquid is an ethoxylated cashew nut shell liquid.

21. The method of claim 16, wherein the non-aqueous phase further comprises a co-solvent.

22. A method of treating an oil and/or gas well having a wellbore, comprising:
delivering a composition into the wellbore, wherein the composition comprises
a microemulsion, wherein the microemulsion comprises:
an aqueous phase;
a surfactant; and
a non-aqueous phase comprising derivatized cashew nut shell liquid;
and wherein the composition enhances flowback and oil and/or gas production from the wellbore.

23. The method of claim 22, wherein the derivatized cashew nut shell liquid is an ethoxylated cashew nut shell liquid.

24. The method of claim 22, wherein the well has a total dissolved solids from about 90,000 mg/L to about 350,000 mg/L.

25. A method of treating an oil and/or gas well having a wellbore, comprising:
delivering a microemulsion into the wellbore, wherein the microemulsion comprises:
an aqueous phase;
a surfactant; and
a non-aqueous phase comprising at least one terpene and at least one additive, wherein the additive is an aromatic compound having a melting point above 15° C. selected from the group consisting of derivatized and underivatized naphthalene, anthracene, phenanthrene, pyrene, fluoranthene, benzopyrene, chrysene, perylene, phenol, catechol, aminophenol, coniferyl alcohol and esters thereof, synapyl alcohol, syringol, syringaldehyde, syringic acid, acetosyringone, sinapine, canolol, cannabinol, cannabidiol, phenolic resins, lignin, derivatized lignin, derivatized cashew nut shell liquid, ethoxylated cashew nut shell liquid, and combinations thereof; and
wherein the microemulsion enhances flowback and oil and/or gas production from the wellbore.

26. The method of claim 25, wherein the aromatic compound comprises naphthalene.

27. The method of claim 25, wherein the well has a total dissolved solids from about 90,000 mg/L to about 350,000 mg/L.
